(19) United States
(12) Patent Application Publication
(10) Pub. No.: US 2026/0270083 A1
(43) Pub. Date: Sep. 10, 2026

(54) BEI_24HWS_TrustScore Graph Engine for Sovereign Behavioral Identity Systems

(71) Applicant: FURONG BEI, SAN GABRIEL, CA (US)

(72) Inventor: FURONG BEI, SAN GABRIEL, CA (US)

(21) Appl. No.: 19/179,340

(22) Filed: Apr. 15, 2025

(51) Int. Cl. H04L 9/32; H04L 9/40

(52) U.S. Cl. CPC H04L 9/3247; H04L 9/3213; H04L 9/3218; H04L 9/40

(57) ABSTRACT

A TrustScore Graph Engine for building Behavioral Economic Identity (BEI) trust infrastructure across digital, institutional, and economic networks is disclosed. The engine models behavioral identities, authenticated behavior events, devices, institutions, regulatory domains, domain nodes, terminal nodes, and automated service nodes as graph nodes connected by directed trust edges carrying TrustScore values, timestamps, verification contexts, behavioral entropy factors, ledger anchors, delegation states, revocation states, and temporal freshness parameters. The engine computes direct and transitive trust-path confidence using time-decay weighting, behavioral-entropy normalization, context overlays, and threshold access rules. Offline trust graph snapshots stored in local KeyCache, SIM, NFC, browser-agent, or terminal memory enable limited local validation during disconnected operation and synchronization after network restoration. Signed delegation tokens are converted into weighted trust edges to support scoped authorization, inheritance, recovery, expiration, and revocation.

### CROSS-REFERENCE TO RELATED APPLICATIONS

CROSS-REFERENCE TO RELATED APPLICATIONS. This application may claim benefit of, be a continuation-in-part of, or otherwise be related to one or more earlier U.S. nonprovisional, provisional, PCT, or companion applications identified in an Application Data Sheet or other accepted USPTO filing record. Any domestic benefit, continuation, continuation-in-part, divisional, priority, or other continuity relationship intended to be relied upon is claimed only to the extent properly set forth in the Application Data Sheet or other accepted USPTO filing record. Applications actually listed in the Application Data Sheet may be referenced as parent applications, and applications not listed in the Application Data Sheet may be referenced only as related, companion, branch, implementation, background, or ecosystem-support applications.

### TITLE AND FIELD

The disclosed subject matter relates to decentralized digital identity, graph-based trust computation, and cross-network trust architectures and, more particularly, to a TrustScore Graph Engine for building Behavioral Economic Identity (BEI) trust infrastructure across digital, institutional, and economic networks operating in online, offline, terminal-based, domain-integrated, and peer-synchronized environments.

The system provides a machine-readable trust infrastructure for establishing, computing, propagating, validating, delegating, recovering, and synchronizing trust relationships among behavioral identities, authenticated behavioral events, devices, terminals, domain nodes, institutions, delegated recipients, automated service nodes, recovery participants, and other cross-network entities across personal, family, institutional, financial, medical, community, government, terminal, and domain-node environments.

As used herein, Behavioral Economic Identity (BEI) trust infrastructure refers to a computer-implemented, machine-readable trust computation framework configured to operate across digital, institutional, and economic networks; represent behavioral identities, authenticated behavior events, devices, institutions, regulatory domains, domain nodes, terminal nodes, and automated service nodes as graph nodes; represent trust assertions, delegation assertions, recovery assertions, permission assertions, and access-control assertions as directed trust edges; compute direct or transitive trust-path confidence using TrustScore values, timestamps, verification contexts, behavioral entropy factors, ledger anchors, revocation states, temporal freshness factors, scope constraints, and threshold access rules; and support identity verification, delegated authorization, offline trust validation, recovery credentialing, auditable state transition recording, progressive disclosure, and domain-terminal interoperability.

In one implementation, the TrustScore Graph Engine receives a validation request object, identifies relevant behavioral identity nodes and trust edges, checks timestamps, scopes, contexts, revocation states, and ledger anchors, computes a direct or transitive trust-path score, and returns a validation result object indicating an access decision, disclosure level, synchronization status, and any required step-up verification or manual review.

In another implementation, the engine operates in a reduced local mode using a cached trust graph snapshot stored in KeyCache, SIM, NFC, browser-agent memory, secure local storage, terminal memory, or an equivalent offline credential store, thereby enabling time-limited, scope-limited, and auditable trust validation during disconnected operation.

### GENERAL IMPLEMENTATION AND EQUIVALENT STRUCTURES

The system is directed to a TrustScore graph in which behavioral identity nodes and authenticated behavior event nodes are connected by directed trust edges carrying trust weights, timestamps, verification contexts, scope limitations, signatures, expiration states, and ledger anchors.

The disclosed implementation is not limited to a single server, a single application, or a single identity credential. The TrustScore Graph Engine may operate across local terminals, browser agents, SIM or NFC storage, domain verification portals, peer devices, and network-based ActionLedger services.

The data structures used for the disclosed trust infrastructure may include identifiers, source and target fields, trust weights, context fields, timestamps, expiration values, signatures, ledger anchor references, revocation states, and policy outputs. These fields provide enablement for concrete processing and are not merely labels for a human trust relationship.

The described arrangements for the disclosed trust infrastructure are compatible with broad functional equivalents. For example, a graph may be stored as adjacency lists, path tables, edge objects, credential relationship maps, tree overlays, mesh overlays, or equivalent structures that preserve node, edge, context, and trust path semantics.

The technical effect of the disclosed trust infrastructure is to improve the reliability and deployability of behavioral identity validation by making the trust state computable, auditable, time-sensitive, locally cacheable, and capable of being synchronized after disconnected operation.

### TECHNICAL PROBLEMS ADDRESSED

Conventional identity verification systems commonly rely on static credentials, centralized account databases, device tokens, or one-time authentication ceremonies. Such systems may identify a person at a moment in time, but they do not compute dynamic trust relationships among behavior, time, context, devices, institutions, and delegated actors.

Conventional recovery mechanisms often rely on a preselected contact, a mobile number, an e-mail address, or platform-controlled account recovery. These mechanisms do not provide a general graph engine for validating multiple trust paths, weighted delegation, localized offline operation, revocation status, and threshold-based authorization.

For technical problems addressed, each described component may be implemented as a software module, local terminal routine, domain node routine, stored data object, signed credential object, graph edge object, or processor-executed step. The implementation may be distributed across devices while retaining a common graph model in which trust is evaluated through signed relationships rather than through a single static identifier.

In one implementation of technical problems addressed, the TrustScore Graph Engine receives an input object, identifies relevant nodes and edges, checks timestamps and contexts, verifies signatures or ledger references, selects candidate paths, computes or updates a confidence value, and returns a validation result suitable for a local service, domain portal, or institutional access environment.

In another implementation of technical problems addressed, the engine operates in a reduced local mode using a cached subgraph. The local mode is configured to permit only time-limited, scope-limited, or policy-limited identity functions until synchronization with a peer node, domain node, or ActionLedger becomes available.

### TECHNICAL PROBLEMS ADDRESSED—CONTINUED

A further technical problem arises when network access is unavailable or unreliable. A device or terminal may need to validate a BEI-ID locally, evaluate a time-limited delegation, or provide emergency access using only a cached subset of a trust graph while avoiding stale trust attacks and replay of old credentials.

The disclosed system addresses these problems by treating trust as a computable graph state supported by signed trust edges, ActionLedger anchors, time-sensitive local snapshots, behavioral entropy factors, domain or terminal interfaces, and synchronizable validation paths.

The data structures used for technical problems addressed may include identifiers, source and target fields, trust weights, context fields, timestamps, expiration values, signatures, ledger anchor references, revocation states, and policy outputs. These fields provide enablement for concrete processing and are not merely labels for a human trust relationship.

The described arrangements for technical problems addressed are compatible with broad functional equivalents. For example, a graph may be stored as adjacency lists, path tables, edge objects, credential relationship maps, tree overlays, mesh overlays, or equivalent structures that preserve node, edge, context, and trust path semantics.

The technical effect of the disclosed technical solution is to improve the reliability and deployability of behavioral identity validation by making the trust state computable, auditable, time-sensitive, locally cacheable, and capable of being synchronized after disconnected operation.

### SUMMARY OF THE INVENTION

In one aspect, the invention provides a TrustScore Graph Engine comprising a plurality of nodes and directed trust edges. The nodes may represent BEI-ID behavioral identities, authenticated behavior events, devices, domain nodes, institution nodes, role nodes, or delegated recipient nodes.

Each directed trust edge may include a TrustScore value, confidence value, path weight, timestamp, verification context, scope parameter, role limitation, expiration condition, signature data, ActionLedger receipt reference, and revocation status.

For summary of the invention, each described component may be implemented as a software module, local terminal routine, domain node routine, stored data object, signed credential object, graph edge object, or processor-executed step. The implementation may be distributed across devices while retaining a common graph model in which trust is evaluated through signed relationships rather than through a single static identifier.

In one implementation of summary of the invention, the TrustScore Graph Engine receives an input object, identifies relevant nodes and edges, checks timestamps and contexts, verifies signatures or ledger references, selects candidate paths, computes or updates a confidence value, and returns a validation result suitable for a local service, domain portal, or institutional access environment.

In another implementation of summary of the invention, the engine operates in a reduced local mode using a cached subgraph. The local mode is configured to permit only time-limited, scope-limited, or policy-limited identity functions until synchronization with a peer node, domain node, or ActionLedger becomes available.

### SUMMARY OF THE INVENTION—CONTINUED

The TrustScore Graph Engine evaluates direct and transitive trust paths, applies time-decay weighting, evaluates behavioral entropy or signal reliability, checks context overlays, and produces a threshold-based access, authorization, recovery, or denial result.

In another aspect, the invention provides offline validation by storing a limited trust graph snapshot in a KeyCache, local terminal memory, SIM element, NFC module, browser key agent, secure local store, or portable credential memory and by synchronizing later with ActionLedger or peer/domain nodes.

The data structures used for summary of the invention may include identifiers, source and target fields, trust weights, context fields, timestamps, expiration values, signatures, ledger anchor references, revocation states, and policy outputs. These fields provide enablement for concrete processing and are not merely labels for a human trust relationship.

The described arrangements for summary of the invention are compatible with broad functional equivalents. For example, a graph may be stored as adjacency lists, path tables, edge objects, credential relationship maps, tree overlays, mesh overlays, or equivalent structures that preserve node, edge, context, and trust path semantics.

The technical effect of the invention is to improve the reliability and deployability of behavioral identity validation by making the trust state computable, auditable, time-sensitive, locally cacheable, and capable of being synchronized after disconnected operation.

### BROAD FUNCTIONAL EQUIVALENTS

The terminology used in this specification is intended to describe exemplary embodiments and not to limit the invention to a particular commercial name or implementation label. A BEI-ID may also be implemented as a behavioral identity node, authenticated subject node, agent node, device-bound identity node, domain identity node, or verified behavior event node.

A TrustScore may also be implemented as a confidence score, trust weight, reliability value, path confidence metric, risk-adjusted access score, or authorization confidence value. The term TrustScore therefore describes the function of expressing a computed confidence relationship and is not limited to a single scoring formula.

Equivalent implementation language is intended to prevent avoidance by re-naming the same technical structure. The directed graph may be stored as an adjacency list, adjacency matrix, edge table, credential relation map, path table, graph database, distributed object store, domain-node cache, or any equivalent data structure configured to represent nodes, directed trust assertions, timestamps, contexts, signatures, ledger anchors, and validation status.

Equivalent actors may include a human subject, software agent, terminal device, institution, domain node, browser agent, local device, emergency verifier, delegated recipient, or authenticated behavior event. A system that uses different labels for such actors remains within the technical scope when the system computes identity validity, access authority, recovery eligibility, or delegated trust through signed graph relationships and path confidence.

Equivalent outputs may include grant, deny, limit, delay, temporary access, step-up verification, manual review, local emergency authorization, offline credential validation, revocation, synchronization, or a structured validation-result object. The invention is directed to the technical decision infrastructure and is not limited to any particular graphical user interface or commercial service name.

### BROAD FUNCTIONAL EQUIVALENTS—CONTINUED

An ActionLedger may be implemented as an immutable ledger, append-only event log, signed audit trail, tamper-resistant database, blockchain-like repository, time-stamped record store, or equivalent event-anchoring service configured to preserve state transitions associated with trust assertions.

A KeyCache may be implemented as a local trust cache, offline graph snapshot, terminal memory, SIM storage, NFC memory, browser key agent, secure enclave memory, portable credential memory, or equivalent structure capable of storing signed trust objects for local validation.

The data structures used for broad functional equivalents may include identifiers, source and target fields, trust weights, context fields, timestamps, expiration values, signatures, ledger anchor references, revocation states, and policy outputs. These fields provide enablement for concrete processing and are not merely labels for a human trust relationship.

The broad equivalents described herein are limited by the technical core of the invention: behavior-linked identity nodes, trust assertion edges carrying time and context, ledger or audit anchoring, offline graph snapshots, delegated trust edges, revocation or expiration state, and threshold-based graph computation. The specification does not require a particular brand name such as BEI-ID, TrustScore, ActionLedger, KeyCache, or Silent Echo so long as the corresponding technical functions are performed.

The technical effect of broad functional equivalents is to improve the reliability and deployability of behavioral identity validation by making the trust state computable, auditable, time-sensitive, locally cacheable, and capable of being synchronized after disconnected operation.

### BRIEF DESCRIPTION OF THE DRAWINGS

FIG. 1 illustrates an overall TrustScore Graph Engine architecture including BEI-ID nodes, behavior event nodes, trust edges, ActionLedger anchoring, domain nodes, terminal caches, and threshold-based validation outputs.

FIG. 2 illustrates representative node structures, including human BEI-ID nodes, device nodes, institution nodes, domain nodes, and behavior event nodes.

FIG. 3 illustrates representative directed trust edge fields and their relationship to scoring and verification.

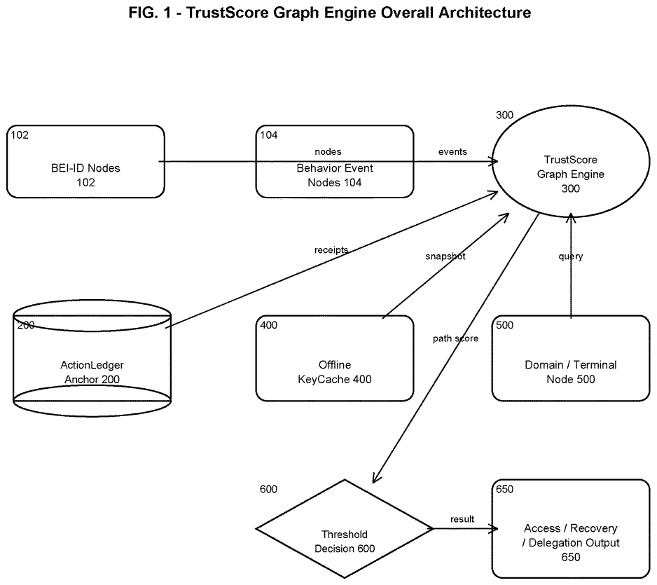

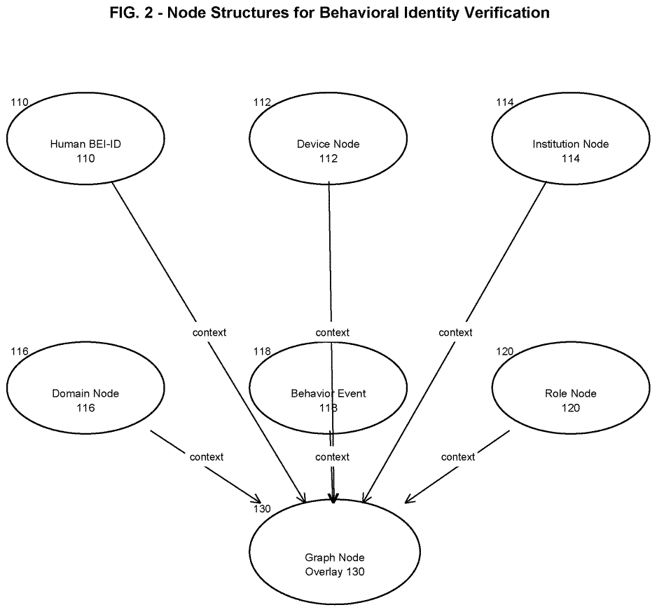

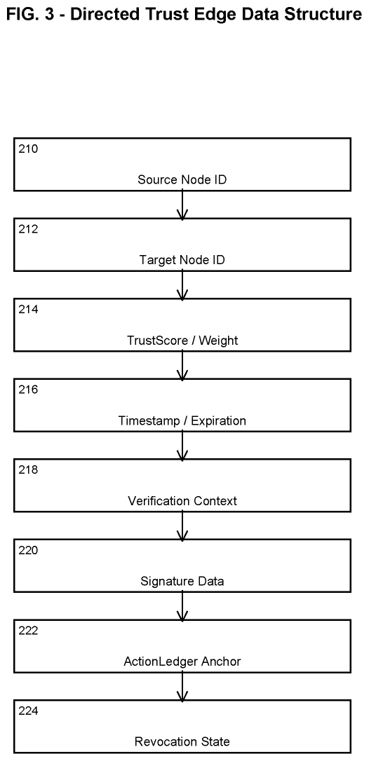

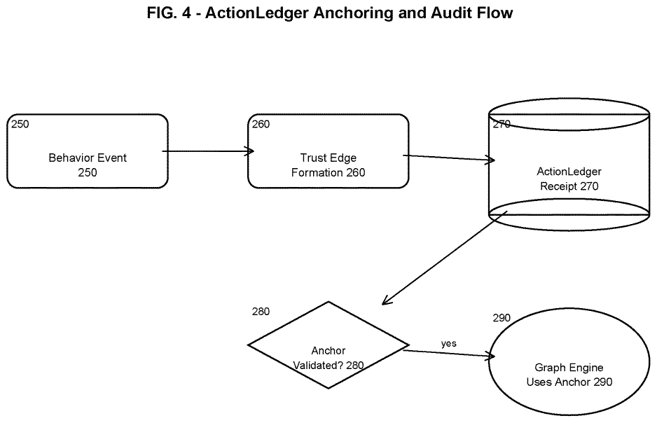

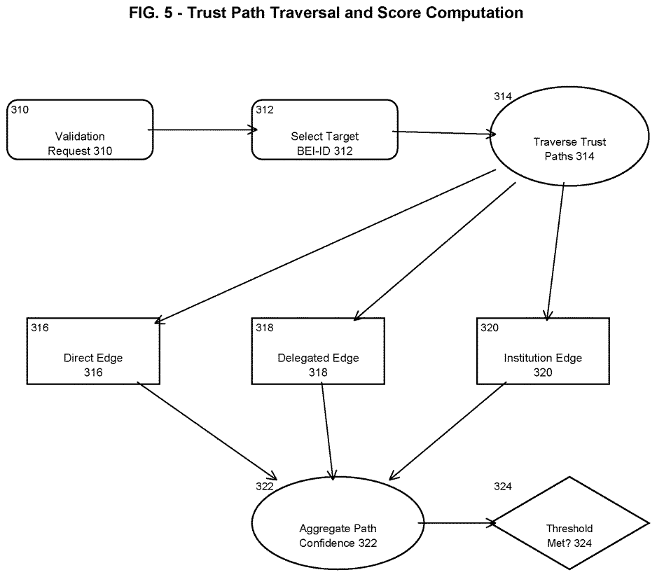

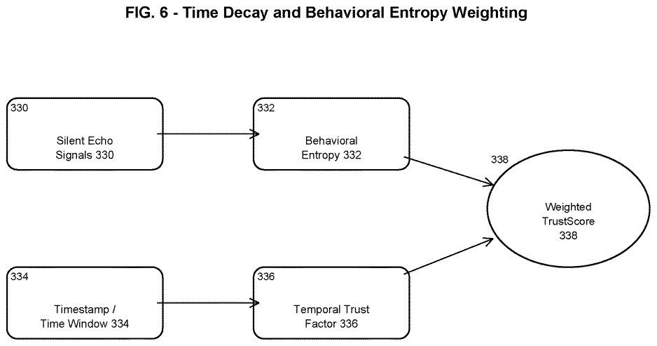

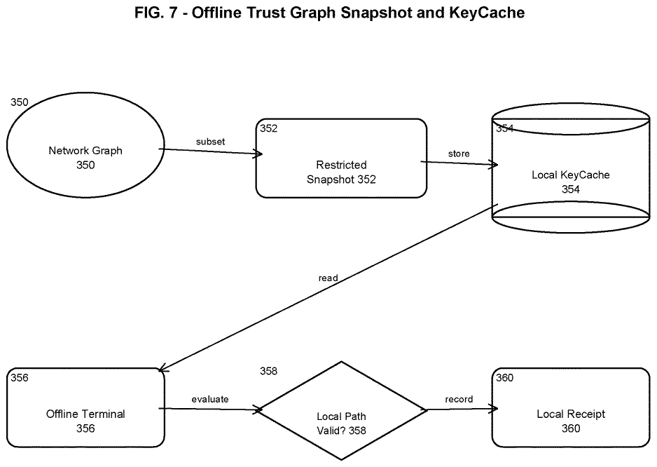

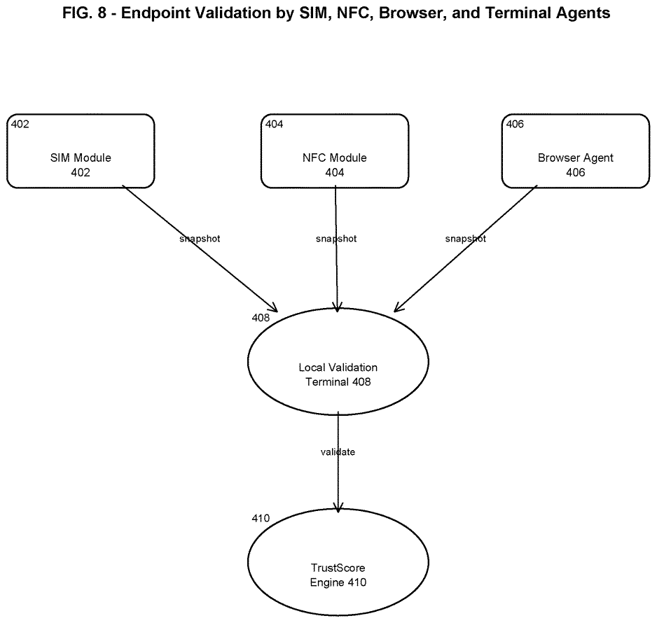

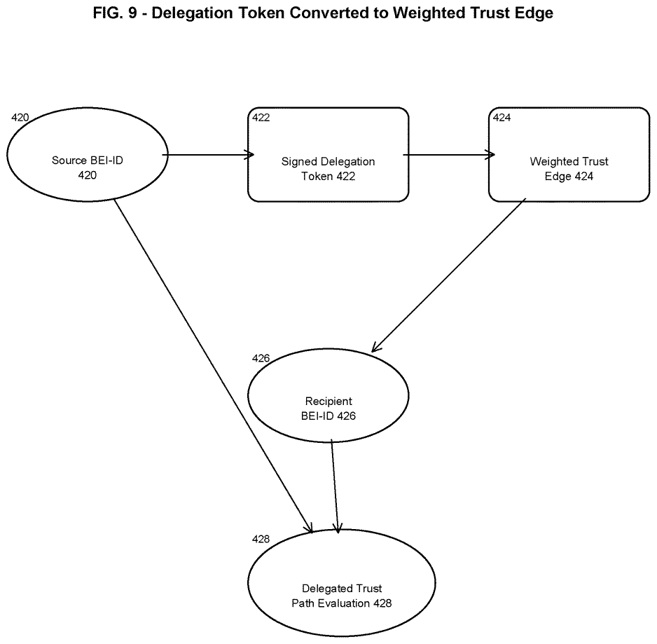

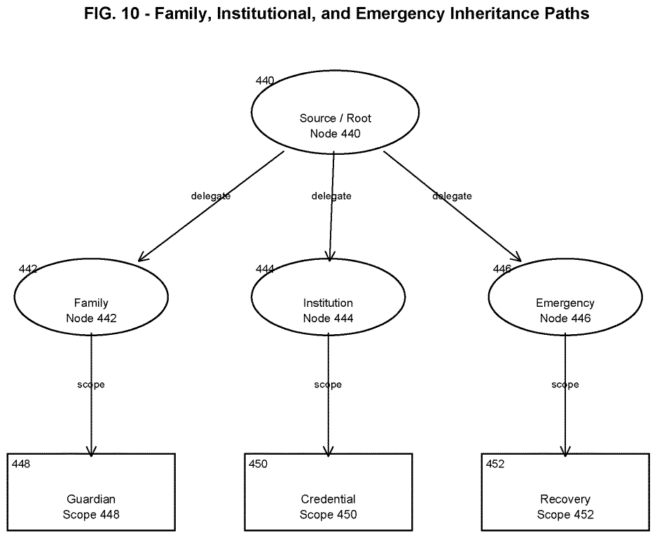

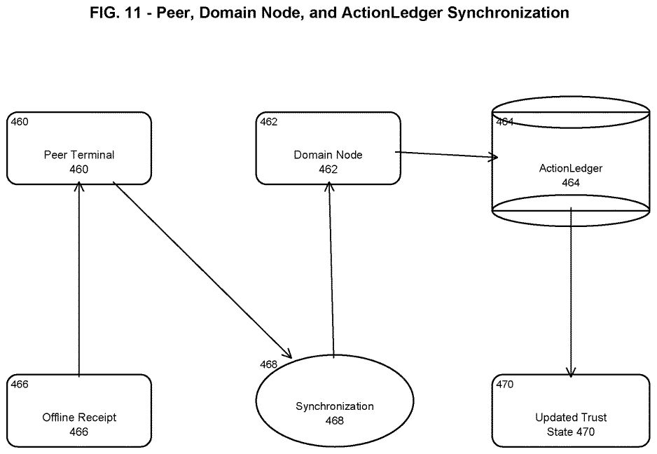

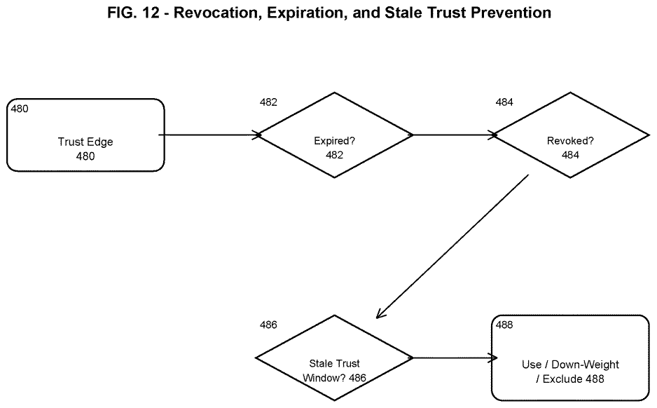

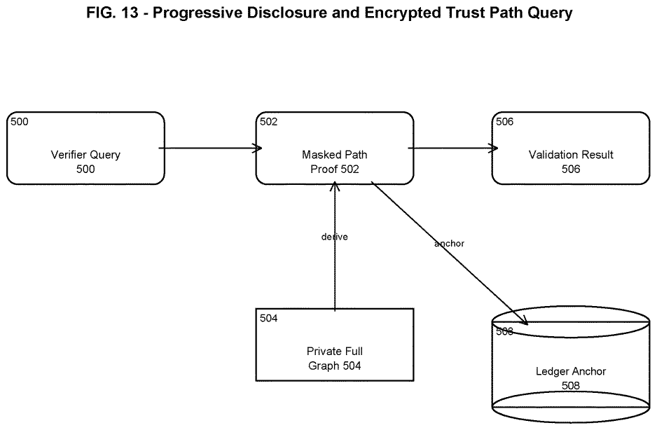

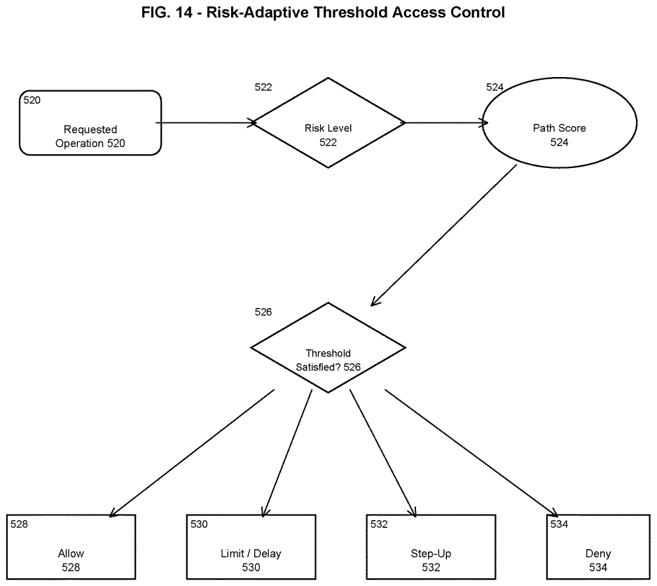

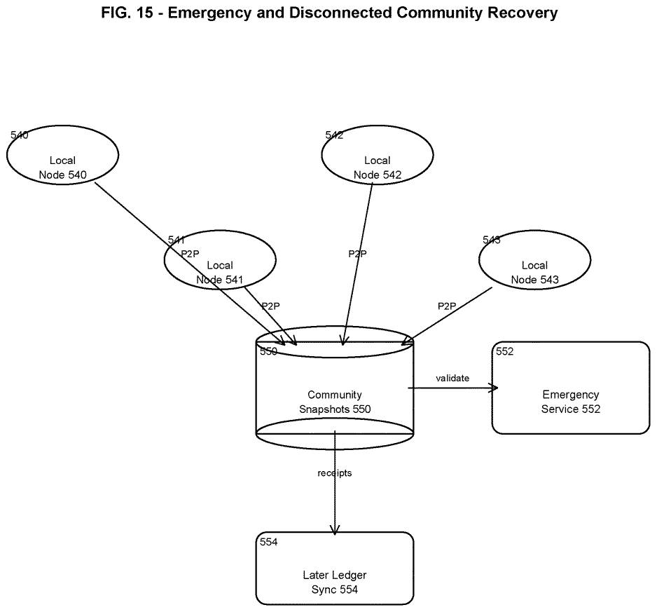

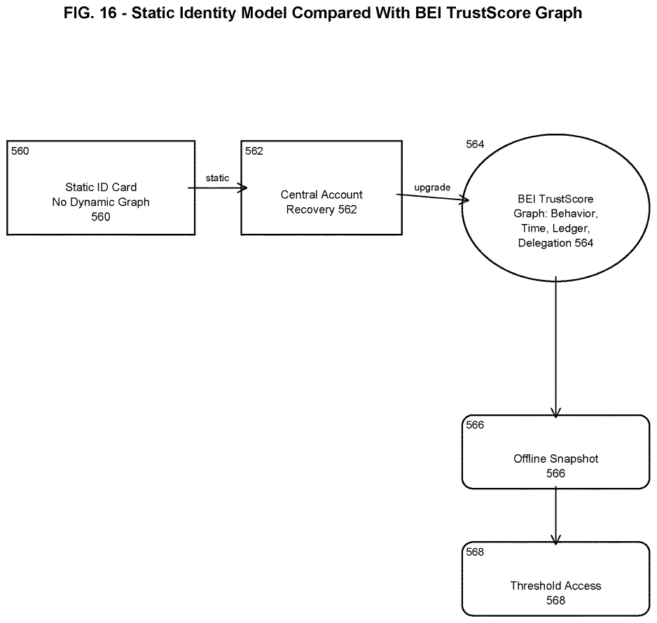

For brief description of the drawings, each described component may be implemented as a software module, local terminal routine, domain node routine, stored data object, signed credential object, graph edge object, or processor-executed step. The implementation may be distributed across devices while retaining a common graph model in which trust is evaluated through signed relationships rather than through a single static identifier.

In one implementation of brief description of the drawings, the TrustScore Graph Engine receives an input object, identifies relevant nodes and edges, checks timestamps and contexts, verifies signatures or ledger references, selects candidate paths, computes or updates a confidence value, and returns a validation result suitable for a local service, domain portal, or institutional access environment.

In another implementation of brief description of the drawings, the engine operates in a reduced local mode using a cached subgraph. The local mode is configured to permit only time-limited, scope-limited, or policy-limited identity functions until synchronization with a peer node, domain node, or ActionLedger becomes available.

### BRIEF DESCRIPTION OF THE DRAWINGS—CONTINUED

FIGS. 4 through 8 illustrate ActionLedger anchoring, trust path traversal, time decay and entropy weighting, offline KeyCache snapshots, and SIM, NFC, browser, and terminal based validation modules.

FIGS. 9 through 16 illustrate signed delegation tokens, family and institutional inheritance paths, domain synchronization, revocation and expiration, progressive disclosure, threshold-based access control, emergency recovery, and a comparison between static identity and dynamic TrustScore graphs.

The data structures used for brief description of the drawings may include identifiers, source and target fields, trust weights, context fields, timestamps, expiration values, signatures, ledger anchor references, revocation states, and policy outputs. These fields provide enablement for concrete processing and are not merely labels for a human trust relationship.

The described arrangements for brief description of the drawings are compatible with broad functional equivalents. For example, a graph may be stored as adjacency lists, path tables, edge objects, credential relationship maps, tree overlays, mesh overlays, or equivalent structures that preserve node, edge, context, and trust path semantics.

The technical effect of brief description of the drawings is to improve the reliability and deployability of behavioral identity validation by making the trust state computable, auditable, time-sensitive, locally cacheable, and capable of being synchronized after disconnected operation.

### Definitions—BEI-ID and Behavior Event Node

A BEI-ID is a behavioral economic identity identifier, node, credential, or graph object associated with an identity subject, user, agent, terminal, device, institutional actor, or domain-linked entity. A BEI-ID may be created, verified, updated, delegated, or recovered through behavioral evidence and graph relationships.

A behavior event node represents an authenticated action, observation, interaction, service request, device event, proximity event, institutional validation, or other event that can contribute to the trust state of a BEI-ID. A behavior event node may be anchored to an ActionLedger entry or equivalent auditable record.

For definitions—bei-id and behavior event node, each described component may be implemented as a software module, local terminal routine, domain node routine, stored data object, signed credential object, graph edge object, or processor-executed step. The implementation may be distributed across devices while retaining a common graph model in which trust is evaluated through signed relationships rather than through a single static identifier.

In one implementation of definitions—bei-id and behavior event node, the TrustScore Graph Engine receives an input object, identifies relevant nodes and edges, checks timestamps and contexts, verifies signatures or ledger references, selects candidate paths, computes or updates a confidence value, and returns a validation result suitable for a local service, domain portal, or institutional access environment.

In another implementation of definitions—bei-id and behavior event node, the engine operates in a reduced local mode using a cached subgraph. The local mode is configured to permit only time-limited, scope-limited, or policy-limited identity functions until synchronization with a peer node, domain node, or ActionLedger becomes available.

### Definitions—BEI-ID and Behavior Event Node—Continued

The TrustScore Graph Engine may represent both BEI-ID nodes and behavior event nodes within a common graph so that identity is not limited to a static credential but is supported by behavior-derived evidence distributed across time, context, and trust relationships.

In some embodiments, a node includes a role identifier, context identifier, domain identifier, device identifier, or scope field. These fields allow the same BEI-ID or actor to have different trust states in medical, institutional, family, domain, emergency, or local terminal contexts.

The data structures used for definitions—bei-id and behavior event node may include identifiers, source and target fields, trust weights, context fields, timestamps, expiration values, signatures, ledger anchor references, revocation states, and policy outputs. These fields provide enablement for concrete processing and are not merely labels for a human trust relationship.

The described arrangements for definitions—bei-id and behavior event node are compatible with broad functional equivalents. For example, a graph may be stored as adjacency lists, path tables, edge objects, credential relationship maps, tree overlays, mesh overlays, or equivalent structures that preserve node, edge, context, and trust path semantics.

The technical effect of definitions—bei-id and behavior event node is to improve the reliability and deployability of behavioral identity validation by making the trust state computable, auditable, time-sensitive, locally cacheable, and capable of being synchronized after disconnected operation.

### Definitions—Trust Edge and Verification Context

A directed trust edge is a graph object connecting a source node to a target node and representing a trust assertion, permission assertion, recovery assertion, delegation assertion, credential relationship, or path segment used in trust computation.

The directed trust edge may include a TrustScore value, timestamp, verification context, cryptographic signature, ledger anchor, source node identifier, target node identifier, scope, role, expiration time, revocation flag, proximity metadata, device status, and confidence adjustment factor.

For definitions—trust edge and verification context, each described component may be implemented as a software module, local terminal routine, domain node routine, stored data object, signed credential object, graph edge object, or processor-executed step. The implementation may be distributed across devices while retaining a common graph model in which trust is evaluated through signed relationships rather than through a single static identifier.

In one implementation of definitions—trust edge and verification context, the TrustScore Graph Engine receives an input object, identifies relevant nodes and edges, checks timestamps and contexts, verifies signatures or ledger references, selects candidate paths, computes or updates a confidence value, and returns a validation result suitable for a local service, domain portal, or institutional access environment.

In another implementation of definitions—trust edge and verification context, the engine operates in a reduced local mode using a cached subgraph. The local mode is configured to permit only time-limited, scope-limited, or policy-limited identity functions until synchronization with a peer node, domain node, or ActionLedger becomes available.

### Definitions—Trust Edge and Verification Context—Continued

The verification context may include geographic context, temporal context, institutional context, domain context, device context, behavioral context, proximity context, or any combination thereof. Context is used to limit or weight the effect of a trust edge during path evaluation.

By storing trust relationships as directed edges rather than static attributes, the system can evaluate local trust, transitive trust, delegated trust, inherited trust, and emergency recovery trust using a unified graph model.

The data structures used for definitions—trust edge and verification context may include identifiers, source and target fields, trust weights, context fields, timestamps, expiration values, signatures, ledger anchor references, revocation states, and policy outputs. These fields provide enablement for concrete processing and are not merely labels for a human trust relationship.

The described arrangements for definitions—trust edge and verification context are compatible with broad functional equivalents. For example, a graph may be stored as adjacency lists, path tables, edge objects, credential relationship maps, tree overlays, mesh overlays, or equivalent structures that preserve node, edge, context, and trust path semantics.

The technical effect of definitions—trust edge and verification context is to improve the reliability and deployability of behavioral identity validation by making the trust state computable, auditable, time-sensitive, locally cacheable, and capable of being synchronized after disconnected operation.

### Definitions—Trustscore Graph Engine

The TrustScore Graph Engine is a processor-implemented, terminal-implemented, domain-implemented, or distributed graph computation engine configured to evaluate trust relationships among nodes and directed edges.

The engine may execute on one or more processors of a local terminal, browser-based agent, mobile device, SIM module, NFC module, domain verification node, network service, server cluster, or peer-to-peer node. The engine need not be limited to a single physical computer.

For definitions—trustscore graph engine, each described component may be implemented as a software module, local terminal routine, domain node routine, stored data object, signed credential object, graph edge object, or processor-executed step. The implementation may be distributed across devices while retaining a common graph model in which trust is evaluated through signed relationships rather than through a single static identifier.

In one implementation of definitions—trustscore graph engine, the TrustScore Graph Engine receives an input object, identifies relevant nodes and edges, checks timestamps and contexts, verifies signatures or ledger references, selects candidate paths, computes or updates a confidence value, and returns a validation result suitable for a local service, domain portal, or institutional access environment.

In another implementation of definitions—trustscore graph engine, the engine operates in a reduced local mode using a cached subgraph. The local mode is configured to permit only time-limited, scope-limited, or policy-limited identity functions until synchronization with a peer node, domain node, or ActionLedger becomes available.

### Definitions—Trustscore Graph Engine—Continued

The engine performs graph traversal, path selection, score aggregation, time-decay weighting, entropy weighting, revocation checking, context filtering, and threshold comparison. The output may be an allow decision, deny decision, delayed decision, limited access decision, step-up verification requirement, recovery decision, or synchronization result.

The engine may maintain different graph overlays for personal trust, institutional trust, domain trust, emergency trust, device trust, role trust, or offline trust. Such overlays can be evaluated separately or fused into a composite score.

The data structures used for definitions—trustscore graph engine may include identifiers, source and target fields, trust weights, context fields, timestamps, expiration values, signatures, ledger anchor references, revocation states, and policy outputs. These fields provide enablement for concrete processing and are not merely labels for a human trust relationship.

The described arrangements for definitions—trustscore graph engine are compatible with broad functional equivalents. For example, a graph may be stored as adjacency lists, path tables, edge objects, credential relationship maps, tree overlays, mesh overlays, or equivalent structures that preserve node, edge, context, and trust path semantics.

The technical effect of definitions—trustscore graph engine is to improve the reliability and deployability of behavioral identity validation by making the trust state computable, auditable, time-sensitive, locally cacheable, and capable of being synchronized after disconnected operation.

### ActionLedger Anchoring

An ActionLedger anchor associates a trust assertion, behavior event, delegation token, revocation event, synchronization event, or access decision with an auditable record. The anchor may be a ledger entry, hash reference, receipt identifier, signed audit event, timestamped record, or equivalent immutable state reference.

The ActionLedger is not merely a storage log. In the disclosed system it provides a verification reference used by the TrustScore Graph Engine to determine whether a trust edge or behavior event has a valid origin, timestamp, revocation state, or synchronization state.

For actionledger anchoring, each described component may be implemented as a software module, local terminal routine, domain node routine, stored data object, signed credential object, graph edge object, or processor-executed step. The implementation may be distributed across devices while retaining a common graph model in which trust is evaluated through signed relationships rather than through a single static identifier.

In one implementation of actionledger anchoring, the TrustScore Graph Engine receives an input object, identifies relevant nodes and edges, checks timestamps and contexts, verifies signatures or ledger references, selects candidate paths, computes or updates a confidence value, and returns a validation result suitable for a local service, domain portal, or institutional access environment.

In another implementation of actionledger anchoring, the engine operates in a reduced local mode using a cached subgraph. The local mode is configured to permit only time-limited, scope-limited, or policy-limited identity functions until synchronization with a peer node, domain node, or ActionLedger becomes available.

### ActionLedger Anchoring—Continued

During trust path evaluation, a trust edge may be down-weighted, excluded, or treated as unresolved if its ActionLedger anchor cannot be validated, if its revocation state is inconsistent, or if the ledger state indicates that an associated delegation has expired or been withdrawn.

When an offline device later reconnects, locally generated receipts, verification decisions, or trust updates may be reconciled with the ActionLedger so that the distributed trust graph remains auditable across offline and online periods.

The data structures used for actionledger anchoring may include identifiers, source and target fields, trust weights, context fields, timestamps, expiration values, signatures, ledger anchor references, revocation states, and policy outputs. These fields provide enablement for concrete processing and are not merely labels for a human trust relationship.

The described arrangements for actionledger anchoring are compatible with broad functional equivalents. For example, a graph may be stored as adjacency lists, path tables, edge objects, credential relationship maps, tree overlays, mesh overlays, or equivalent structures that preserve node, edge, context, and trust path semantics.

The technical effect of actionledger anchoring is to improve the reliability and deployability of behavioral identity validation by making the trust state computable, auditable, time-sensitive, locally cacheable, and capable of being synchronized after disconnected operation.

Silent Echo behavioral entropy is a behavioral evidence source that provides passive or low-intrusion behavioral signals to the TrustScore Graph Engine. In representative embodiments, such signals include timing patterns, device usage rhythms, navigation trajectories, interaction sequences, sensor-derived motion patterns, and contextual usage patterns collected by an authorized terminal, browser agent, mobile device, SIM/NFC module, or domain-linked identity agent.

The Silent Echo module does not merely identify a person through a static biometric or credential. It supplies behavior-derived evidence that can be converted into a behavioral entropy value, quality score, or reliability factor indicating the distinctiveness, freshness, and richness of the behavioral signal supporting a trust assertion, edge signature, local validation, or delegated trust path.

The behavioral entropy value may be used by the TrustScore Computation Engine as a weighting factor during local aggregation and recursive transitive path traversal. For example, an edge supported by high-quality behavioral evidence may receive a greater effective contribution than an edge supported only by sparse, old, or low-information behavioral evidence, subject to time decay and context overlays.

The behavioral entropy value may also participate in cryptographic binding of a trust assertion. In some embodiments, behavior-derived entropy contributes to key material, signature strengthening, liveness evaluation, replay-resistance checks, or validation of whether a trust assertion remains linked to the originating behavioral identity rather than merely to a copied static credential.

Silent Echo signals may be stored directly in a node, indirectly referenced through an ActionLedger record, summarized as entropy metadata on a directed edge, or cached inside an offline trust graph snapshot. The actual raw behavioral data need not be disclosed to every verifier; the system may expose only an entropy score, proof object, commitment, or trust-weight contribution appropriate to the requested disclosure level.

When the TrustScore Graph Engine evaluates a trust path, behavioral entropy may be applied independently to each edge or may be aggregated across a path. The engine may discount edges having insufficient behavioral evidence, request step-up verification, or require a fresh local signal before granting higher-risk access or delegated authority.

The Silent Echo module therefore distinguishes the invention from a conventional social graph, issuer-only credential, or account recovery contact list. The graph is grounded in behavior-derived evidence, not only in a static assertion that one node recognizes another node.

Behavioral entropy may be normalized against a deployment-specific maximum or baseline so that the contribution of a signal can be compared across devices, domains, or institutions without requiring identical sensors. This permits international and cross-platform deployment while preserving the core technical concept of behavior-bound trust weighting.

In constrained or offline embodiments, the KeyCache may store pre-computed entropy metadata, behavior-bound signatures, or commitment receipts. Offline validation can then benefit from previously computed behavioral evidence while still enforcing snapshot expiration, revocation state, and synchronization requirements.

In delegated trust embodiments, a delegated edge may carry entropy context from the source, recipient, or delegation ceremony. The engine may evaluate whether inherited trust remains behaviorally grounded before permitting scope-limited access, family recovery, institutional authorization, or emergency local validation.

The use of Silent Echo behavioral entropy is optional in some low-assurance contexts and more stringent in high-assurance contexts. This allows the same graph engine to support routine access with low friction while requiring stronger behavior-linked proof for high-risk operations.

The system may combine Silent Echo behavioral entropy with timestamps, time windows, device context, proximity context, institutional overlays, and ActionLedger anchors. The combination supports a layered validation architecture in which no single signal alone controls the final trust decision.

Equivalent passive behavioral signal sources may replace or supplement Silent Echo. The term Silent Echo is therefore exemplary of a behavioral evidence module that provides behavior-derived entropy for scoring, signing, liveness evaluation, replay resistance, or path confidence.

The technical effect of the Silent Echo behavioral entropy component is to convert behavioral evidence into a computable graph input used by the TrustScore Graph Engine, thereby increasing resistance to static credential theft, reducing reliance on central account recovery, and improving behavior-bound identity validation in online and offline environments.

A temporal trust factor may be applied to each directed trust edge, delegation token, KeyCache snapshot, ActionLedger receipt, or validation result. The temporal trust factor may be based on a timestamp, last-validation time, expiration time, not-before time, not-after time, sliding validation window, temporal context class, or time-decay parameter.

The temporal trust factor is not used to create a separate time-currency invention in this application. In the present TrustScore Graph Engine, time is used as a technical input for freshness, decay, revocation, replay resistance, offline validity, and delegated authority expiration.

The engine may compute a temporal freshness value indicating whether a trust assertion remains reliable for the requested scope. Older assertions may be down-weighted, excluded, or subjected to step-up verification when the elapsed time, expiration condition, or time-window policy indicates excessive uncertainty.

The temporal trust factor may be combined with behavioral entropy information. A trust edge can therefore be weighted by both behavioral distinctiveness and temporal freshness, so that a recent behavior-bound edge can contribute differently from an older or low-entropy edge having the same base TrustScore.

In privacy-preserving embodiments, a proof object may show that a time-related policy has been satisfied without revealing more timing information than necessary. For example, a verifier may receive proof that an edge falls within a permitted validation window, that a delegation is not expired, or that a snapshot is sufficiently fresh, without receiving all underlying timing data.

Such a proof object may be implemented as a signed time-window assertion, ledger-anchored time receipt, zero-knowledge proof, commitment proof, or equivalent cryptographic statement. The proof is used as part of verification context for the graph engine and does not require disclosure of unrelated behavioral, family, institutional, or path details.

Offline graph snapshots stored in a KeyCache may include timestamp fields, expiration fields, temporal confidence metadata, and proof references. During offline validation, the engine applies the temporal trust factor before computing or accepting a local TrustScore result.

The temporal trust factor also supports delegated trust. A signed delegation token may include a time constraint, renewal condition, event-triggered expiration, or temporal context requirement; the engine enforces the time constraint when evaluating inherited trust paths.

Temporal context may include routine access, off-hours access, emergency access, high-frequency repeated access, deadline-driven access, or event-sequenced access. The context may modify thresholds without requiring a different graph for each time condition.

The temporal trust factor reduces stale trust attacks by limiting the usefulness of old cached credentials or old trust assertions. If an attacker replays an old edge, token, or snapshot, the time-window, decay, revocation, and proof checks may reduce or eliminate the resulting trust contribution.

The engine may reconcile temporal metadata during synchronization. When a terminal reconnects to a domain node, peer device, or ActionLedger, updated timestamps, revocation times, expiration states, and proof references may be merged into the local graph snapshot.

The temporal trust factor is compatible with international standards and external time sources when available. A deployment may use local clocks, signed server timestamps, domain-node timestamps, ledger timestamps, trusted time services, or equivalent time evidence, provided the resulting time state is bound to the trust edge or snapshot being verified.

In the claims and embodiments, terms such as timestamp, time constraint, time window, expiration, decay model, validation window, and temporal context are exemplary ways of expressing temporal trust information. Substitution of another equivalent temporal proof or freshness mechanism does not avoid the technical operation of the invention when used to compute or validate trust paths.

The technical effect of temporal trust factors is to make TrustScore computation time-sensitive, to prevent indefinite reliance on stale relationships, to make offline operation safer, and to permit time-bound delegation without converting the invention into a financial time-token or currency-minting system.

### Trustscore Computation—Local Signals

The engine may compute an initial local TrustScore contribution from direct signals associated with a source node and a target node. Direct signals may include prior verified interactions, physical proximity metadata, co-location indicators, device authentication status, institutional validation, domain portal validation, or ActionLedger-confirmed events.

The local TrustScore may be adjusted based on verification context. For example, a trust edge may be strong for an institutional access function but weak for a family delegation function, or valid during a time window but invalid after expiration.

For trustscore computation-local signals, each described component may be implemented as a software module, local terminal routine, domain node routine, stored data object, signed credential object, graph edge object, or processor-executed step. The implementation may be distributed across devices while retaining a common graph model in which trust is evaluated through signed relationships rather than through a single static identifier.

In one implementation of trustscore computation-local signals, the TrustScore Graph Engine receives an input object, identifies relevant nodes and edges, checks timestamps and contexts, verifies signatures or ledger references, selects candidate paths, computes or updates a confidence value, and returns a validation result suitable for a local service, domain portal, or institutional access environment.

In another implementation of trustscore computation-local signals, the engine operates in a reduced local mode using a cached subgraph. The local mode is configured to permit only time-limited, scope-limited, or policy-limited identity functions until synchronization with a peer node, domain node, or ActionLedger becomes available.

### Trustscore Computation—Local Signals—Continued

Behavioral entropy and temporal trust factors may be used as multipliers, gates, or normalization factors in local computation. A high-confidence behavior event with recent temporal context may contribute more strongly than an old or low-information event.

The engine may store the computed local contribution as part of the trust edge, as part of a node overlay, or as an intermediate value used during transitive path traversal.

The data structures used for trustscore computation-local signals may include identifiers, source and target fields, trust weights, context fields, timestamps, expiration values, signatures, ledger anchor references, revocation states, and policy outputs. These fields provide enablement for concrete processing and are not merely labels for a human trust relationship.

The described arrangements for trustscore computation-local signals are compatible with broad functional equivalents. For example, a graph may be stored as adjacency lists, path tables, edge objects, credential relationship maps, tree overlays, mesh overlays, or equivalent structures that preserve node, edge, context, and trust path semantics.

The technical effect of trustscore computation-local signals is to improve the reliability and deployability of behavioral identity validation by making the trust state computable, auditable, time-sensitive, locally cacheable, and capable of being synchronized after disconnected operation.

### Trustscore Computation—Transitive Paths

The TrustScore Graph Engine evaluates one or more paths connecting a requesting node, source node, domain node, institution node, or delegated node to a target BEI-ID. The engine may perform breadth-first search, depth-limited traversal, weighted path traversal, or other graph traversal suitable for resource-limited terminals.

For each path, the engine may combine edge weights, time-decay factors, behavioral entropy factors, context matches, role compatibility, scope restrictions, and revocation state. A path may be rejected if any required edge is expired, revoked, contextually incompatible, or unsupported by a valid ledger anchor.

For trustscore computation—transitive paths, each described component may be implemented as a software module, local terminal routine, domain node routine, stored data object, signed credential object, graph edge object, or processor-executed step. The implementation may be distributed across devices while retaining a common graph model in which trust is evaluated through signed relationships rather than through a single static identifier.

In one implementation of trustscore computation—transitive paths, the TrustScore Graph Engine receives an input object, identifies relevant nodes and edges, checks timestamps and contexts, verifies signatures or ledger references, selects candidate paths, computes or updates a confidence value, and returns a validation result suitable for a local service, domain portal, or institutional access environment.

In another implementation of trustscore computation-transitive paths, the engine operates in a reduced local mode using a cached subgraph. The local mode is configured to permit only time-limited, scope-limited, or policy-limited identity functions until synchronization with a peer node, domain node, or ActionLedger becomes available.

### Trustscore Computation—Transitive Paths—Continued

Multiple paths may be aggregated to produce a composite path confidence value. The aggregation may be additive, weighted, threshold-based, risk-adjusted, or context-specific, provided that the resulting output expresses confidence for a requested identity, access, recovery, delegation, or local service decision.

By using transitive path evaluation, the system can support situations in which no single centralized authority is available, while avoiding unrestricted social trust by requiring signatures, scopes, timestamps, ledger anchors, and thresholds.

The data structures used for trustscore computation-transitive paths may include identifiers, source and target fields, trust weights, context fields, timestamps, expiration values, signatures, ledger anchor references, revocation states, and policy outputs. These fields provide enablement for concrete processing and are not merely labels for a human trust relationship.

The described arrangements for trustscore computation-transitive paths are compatible with broad functional equivalents. For example, a graph may be stored as adjacency lists, path tables, edge objects, credential relationship maps, tree overlays, mesh overlays, or equivalent structures that preserve node, edge, context, and trust path semantics.

The technical effect of trustscore computation-transitive paths is to improve the reliability and deployability of behavioral identity validation by making the trust state computable, auditable, time-sensitive, locally cacheable, and capable of being synchronized after disconnected operation.

### Threshold-Based Access Decision

The engine compares one or more computed TrustScore path confidence values with a threshold associated with a requested operation. A low-risk request may require a lower threshold, while a high-risk request, recovery request, delegated authority request, or offline service request may require a higher threshold or additional context.

The output of the comparison need not be a binary allow-or-deny result. The system may provide progressive access, such as read-only access, limited access, temporary access, step-up verification, delayed execution, manual review, or denial.

For threshold-based access decision, each described component may be implemented as a software module, local terminal routine, domain node routine, stored data object, signed credential object, graph edge object, or processor-executed step. The implementation may be distributed across devices while retaining a common graph model in which trust is evaluated through signed relationships rather than through a single static identifier.

In one implementation of threshold-based access decision, the TrustScore Graph Engine receives an input object, identifies relevant nodes and edges, checks timestamps and contexts, verifies signatures or ledger references, selects candidate paths, computes or updates a confidence value, and returns a validation result suitable for a local service, domain portal, or institutional access environment.

In another implementation of threshold-based access decision, the engine operates in a reduced local mode using a cached subgraph. The local mode is configured to permit only time-limited, scope-limited, or policy-limited identity functions until synchronization with a peer node, domain node, or ActionLedger becomes available.

### Threshold-Based Access Decision—Continued

Threshold-based outputs reduce false denial while improving security. A user whose trust path is incomplete may still obtain limited local functions or submit additional proof rather than being permanently locked out.

The threshold, risk category, output mode, and required context may be configured by an institution, domain node, terminal, policy cache, or local service environment while remaining compatible with the TrustScore graph structure.

The data structures used for threshold-based access decision may include identifiers, source and target fields, trust weights, context fields, timestamps, expiration values, signatures, ledger anchor references, revocation states, and policy outputs. These fields provide enablement for concrete processing and are not merely labels for a human trust relationship.

The described arrangements for threshold-based access decision are compatible with broad functional equivalents. For example, a graph may be stored as adjacency lists, path tables, edge objects, credential relationship maps, tree overlays, mesh overlays, or equivalent structures that preserve node, edge, context, and trust path semantics.

The technical effect of threshold-based access decision is to improve the reliability and deployability of behavioral identity validation by making the trust state computable, auditable, time-sensitive, locally cacheable, and capable of being synchronized after disconnected operation.

### Offline Snapshot Generation

An offline trust graph snapshot is a restricted subset of the broader TrustScore graph stored on a local device, terminal, SIM element, NFC module, browser key agent, secure storage, or portable credential memory. The snapshot may include verified nodes, signed trust edges, timestamps, contexts, ledger anchors, revocation state, and threshold policies.

The snapshot may be generated while network access is available and then used later when the device or terminal is disconnected. The snapshot is limited by time windows, scope restrictions, and context restrictions so that offline validation does not become an unlimited trust bypass.

For offline snapshot generation, each described component may be implemented as a software module, local terminal routine, domain node routine, stored data object, signed credential object, graph edge object, or processor-executed step. The implementation may be distributed across devices while retaining a common graph model in which trust is evaluated through signed relationships rather than through a single static identifier.

In one implementation of offline snapshot generation, the TrustScore Graph Engine receives an input object, identifies relevant nodes and edges, checks timestamps and contexts, verifies signatures or ledger references, selects candidate paths, computes or updates a confidence value, and returns a validation result suitable for a local service, domain portal, or institutional access environment.

In another implementation of offline snapshot generation, the engine operates in a reduced local mode using a cached subgraph. The local mode is configured to permit only time-limited, scope-limited, or policy-limited identity functions until synchronization with a peer node, domain node, or ActionLedger becomes available.

### Offline Snapshot Generation—Continued

The snapshot may contain only the minimum subgraph needed for a category of local validation, such as emergency identification, family delegation, institutional credential confirmation, domain terminal access, or community-based recovery.

Because the snapshot carries signed edges and ledger references, a local terminal can verify authenticity and freshness without downloading the entire ActionLedger or global graph during the offline period.

The data structures used for offline snapshot generation may include identifiers, source and target fields, trust weights, context fields, timestamps, expiration values, signatures, ledger anchor references, revocation states, and policy outputs. These fields provide enablement for concrete processing and are not merely labels for a human trust relationship.

The described arrangements for offline snapshot generation are compatible with broad functional equivalents. For example, a graph may be stored as adjacency lists, path tables, edge objects, credential relationship maps, tree overlays, mesh overlays, or equivalent structures that preserve node, edge, context, and trust path semantics.

The technical effect of offline snapshot generation is to improve the reliability and deployability of behavioral identity validation by making the trust state computable, auditable, time-sensitive, locally cacheable, and capable of being synchronized after disconnected operation.

### Offline Validation Method

During offline validation, the local device or terminal receives an identity verification request directed to a target BEI-ID or delegated recipient. The terminal retrieves the relevant graph snapshot and identifies candidate trust paths terminating at the target node.

The terminal verifies signatures, checks expiration conditions, evaluates time windows, inspects revocation states, applies context filters, and calculates a localized TrustScore based on the cached graph and available behavioral or temporal metadata.

For offline validation method, each described component may be implemented as a software module, local terminal routine, domain node routine, stored data object, signed credential object, graph edge object, or processor-executed step. The implementation may be distributed across devices while retaining a common graph model in which trust is evaluated through signed relationships rather than through a single static identifier.

In one implementation of offline validation method, the TrustScore Graph Engine receives an input object, identifies relevant nodes and edges, checks timestamps and contexts, verifies signatures or ledger references, selects candidate paths, computes or updates a confidence value, and returns a validation result suitable for a local service, domain portal, or institutional access environment.

In another implementation of offline validation method, the engine operates in a reduced local mode using a cached subgraph. The local mode is configured to permit only time-limited, scope-limited, or policy-limited identity functions until synchronization with a peer node, domain node, or ActionLedger becomes available.

### Offline Validation Method—Continued

If the calculated trust confidence satisfies the applicable threshold, the terminal may permit a local service function, limited identity function, emergency verification, recovery operation, or restricted access. If the confidence is insufficient, the terminal may deny, limit, delay, or request additional verification.

Upon network restoration, the terminal may synchronize local receipts, access decisions, revocation information, and updated trust states with peer nodes, domain nodes, or the ActionLedger.

The data structures used for offline validation method may include identifiers, source and target fields, trust weights, context fields, timestamps, expiration values, signatures, ledger anchor references, revocation states, and policy outputs. These fields provide enablement for concrete processing and are not merely labels for a human trust relationship.

The described arrangements for offline validation method are compatible with broad functional equivalents. For example, a graph may be stored as adjacency lists, path tables, edge objects, credential relationship maps, tree overlays, mesh overlays, or equivalent structures that preserve node, edge, context, and trust path semantics.

The technical effect of offline validation method is to improve the reliability and deployability of behavioral identity validation by making the trust state computable, auditable, time-sensitive, locally cacheable, and capable of being synchronized after disconnected operation.

### KeyCache, SIM, NFC, and Browser Agents

A KeyCache may store cryptographic keys, signed trust edges, local trust graph snapshots, ledger anchor references, revocation state, and synchronization metadata. The KeyCache may be implemented in software, hardware, secure storage, SIM storage, NFC memory, a browser key agent, or a local terminal module.

A SIM-based implementation may be used where a mobile device needs to carry a small subset of the trust graph for emergency or disconnected operation. An NFC implementation may provide tap-based access to a trust packet without requiring full device unlocking.

For keycache, sim, nfc, and browser agents, each described component may be implemented as a software module, local terminal routine, domain node routine, stored data object, signed credential object, graph edge object, or processor-executed step. The implementation may be distributed across devices while retaining a common graph model in which trust is evaluated through signed relationships rather than through a single static identifier.

In one implementation of keycache, sim, nfc, and browser agents, the TrustScore Graph Engine receives an input object, identifies relevant nodes and edges, checks timestamps and contexts, verifies signatures or ledger references, selects candidate paths, computes or updates a confidence value, and returns a validation result suitable for a local service, domain portal, or institutional access environment.

In another implementation of keycache, sim, nfc, and browser agents, the engine operates in a reduced local mode using a cached subgraph. The local mode is configured to permit only time-limited, scope-limited, or policy-limited identity functions until synchronization with a peer node, domain node, or ActionLedger becomes available.

### KeyCache, SIM, NFC, and Browser Agents—Continued

A browser-based key agent may store or access trust graph snapshots for domain-integrated verification portals. The browser agent may participate in validating trust edges, checking ActionLedger anchors, or submitting synchronization receipts to a domain node.

These endpoint implementations provide concrete technical deployment paths for the TrustScore Graph Engine while preserving the general graph model across different device classes.

The data structures used for keycache, sim, nfc, and browser agents may include identifiers, source and target fields, trust weights, context fields, timestamps, expiration values, signatures, ledger anchor references, revocation states, and policy outputs. These fields provide enablement for concrete processing and are not merely labels for a human trust relationship.

The described arrangements for keycache, sim, nfc, and browser agents are compatible with broad functional equivalents. For example, a graph may be stored as adjacency lists, path tables, edge objects, credential relationship maps, tree overlays, mesh overlays, or equivalent structures that preserve node, edge, context, and trust path semantics.

The technical effect of keycache, sim, nfc, and browser agents is to improve the reliability and deployability of behavioral identity validation by making the trust state computable, auditable, time-sensitive, locally cacheable, and capable of being synchronized after disconnected operation.

### Domain Node and Terminal Integration

A domain node may act as a verification portal, trust registry endpoint, synchronization point, institutional gateway, or domain-linked interface for the TrustScore graph. A domain node may validate trust edges, serve policy information, receive synchronization events, or provide external passive verification.

A terminal may be a personal device, mobile endpoint, institutional terminal, browser, service kiosk, emergency terminal, or domain-linked portal. The terminal may store local snapshots and execute local graph evaluation when a network connection is unavailable.

For domain node and terminal integration, each described component may be implemented as a software module, local terminal routine, domain node routine, stored data object, signed credential object, graph edge object, or processor-executed step. The implementation may be distributed across devices while retaining a common graph model in which trust is evaluated through signed relationships rather than through a single static identifier.

In one implementation of domain node and terminal integration, the TrustScore Graph Engine receives an input object, identifies relevant nodes and edges, checks timestamps and contexts, verifies signatures or ledger references, selects candidate paths, computes or updates a confidence value, and returns a validation result suitable for a local service, domain portal, or institutional access environment.

In another implementation of domain node and terminal integration, the engine operates in a reduced local mode using a cached subgraph. The local mode is configured to permit only time-limited, scope-limited, or policy-limited identity functions until synchronization with a peer node, domain node, or ActionLedger becomes available.

### Domain Node and Terminal Integration—Continued

The domain node and terminal may interact using standard or standards-oriented data interfaces, such as signed JSON objects, credential-like payloads, ledger receipt references, public-key signatures, revocation status objects, or API calls suitable for identity verification systems.

By using interoperable data objects rather than a single closed application, the system may integrate with existing identity platforms, access-control services, institutional portals, and domain-based service endpoints while retaining BEI TrustScore graph semantics.

The data structures used for domain node and terminal integration may include identifiers, source and target fields, trust weights, context fields, timestamps, expiration values, signatures, ledger anchor references, revocation states, and policy outputs. These fields provide enablement for concrete processing and are not merely labels for a human trust relationship.

The described arrangements for domain node and terminal integration are compatible with broad functional equivalents. For example, a graph may be stored as adjacency lists, path tables, edge objects, credential relationship maps, tree overlays, mesh overlays, or equivalent structures that preserve node, edge, context, and trust path semantics.

The technical effect of domain node and terminal integration is to improve the reliability and deployability of behavioral identity validation by making the trust state computable, auditable, time-sensitive, locally cacheable, and capable of being synchronized after disconnected operation.

The system may expose standards-oriented interfaces so that existing identity platforms, access management systems, domain portals, browser agents, enterprise applications, medical systems, banking systems, or emergency terminals can call the TrustScore Graph Engine without replacing their entire infrastructure.

A validation request object may include fields such as request_id, source_node_id, target_node_id, requested_scope, requested_role, context_vector, risk_level, disclosure_level, timestamp_or_time_window, nonce, signature, and optional proof_reference. Equivalent field names and object formats may be used.

A validation result object may include fields such as decision, composite_trust_score, access_tier, confidence_band, valid_until, step_up_required, limited_scope, revocation_status, ledger_receipt_reference, proof_object_reference, synchronization_status, and reason_code. The result object may be returned through an API, local terminal interface, domain node, or peer-to-peer channel.

The interface may be implemented as REST, JSON, CBOR, DID/VC-compatible object exchange, signed credential presentation, local IPC call, JavaScript browser API, mobile OS service call, SIM toolkit operation, NFC application protocol data unit, or another machine-readable interface suitable for deployment. The claims are not limited to a particular transport or serialization format.

For compatibility with international identity standards, the graph engine may consume or produce signed credential objects, verification results, revocation status objects, audit receipts, or trust-path proof objects. Such objects may be mapped to existing schemas while preserving the core TrustScore graph computation.

Interoperability does not require exposing the full internal graph. A service provider may call a domain node and receive only an allow, deny, limited, expired, revoked, or step-up result, together with a confidence band and ledger receipt reference when permitted by the disclosure level.

Standards-oriented deployment improves licensing value because third parties can integrate the engine as an overlay to existing multi-factor authentication, decentralized identity, verifiable credential, enterprise access management, emergency identity, or domain-based services.

The interface may support versioning, field extension, and domain-specific profiles. A financial profile, medical profile, enterprise profile, family profile, emergency profile, or institutional profile may use different thresholds and disclosure levels while relying on the same underlying graph objects and validation operations.

Equivalent implementations may use object schemas, claim formats, credentials, tokens, receipts, API fields, event envelopes, or proof containers having different names. They remain within the invention when they encode the same technical relationship among identity nodes, trust edges, context, time, signature, ledger anchor, delegation, and validation decision.

The engine may therefore operate above or beside existing authentication systems. For example, a conventional device confirmation may establish that a user controls a device, while the TrustScore Graph Engine determines whether the behavior identity, delegated authority, trust path, context, and ledger status support the requested operation.

Standards-oriented interfaces also support asset-package use because the same patent-protected engine can be positioned as an interoperable trust decision layer for multiple vertical markets without claiming to replace every existing identity infrastructure.

A domain node may publish an implementation profile identifying supported request fields, result fields, proof types, revocation sources, synchronization methods, and disclosure tiers. This allows independent implementers to connect while preserving trust-path verification requirements.

A terminal may cache the interface profile and validate a subset of requests locally while offline. Upon reconnection, the terminal can synchronize receipts and profile updates with a domain node or ActionLedger.

The technical effect of standards-oriented interfaces is to make the graph engine deployable in real commercial systems as a machine-readable trust decision service while preserving the underlying technical requirements of signed graph relationships, offline snapshots, ledger anchors, and delegated trust paths.

### Delegation Token Structure

A delegation token is a signed data object by which a source BEI-ID node grants limited trust, authority, recovery ability, or identity function to a recipient BEI-ID node. The token may include source, recipient, scope, role, time constraint, context, TrustScore weight, expiration state, and signature.

The TrustScore Graph Engine transforms or maps the delegation token into a weighted directed edge. The edge can then be evaluated using the same graph traversal, time-decay, context, and threshold mechanisms as other trust edges.

For delegation token structure, each described component may be implemented as a software module, local terminal routine, domain node routine, stored data object, signed credential object, graph edge object, or processor-executed step. The implementation may be distributed across devices while retaining a common graph model in which trust is evaluated through signed relationships rather than through a single static identifier.

In one implementation of delegation token structure, the TrustScore Graph Engine receives an input object, identifies relevant nodes and edges, checks timestamps and contexts, verifies signatures or ledger references, selects candidate paths, computes or updates a confidence value, and returns a validation result suitable for a local service, domain portal, or institutional access environment.

In another implementation of delegation token structure, the engine operates in a reduced local mode using a cached subgraph. The local mode is configured to permit only time-limited, scope-limited, or policy-limited identity functions until synchronization with a peer node, domain node, or ActionLedger becomes available.

### Delegation Token Structure—Continued

The scope parameter limits the functions for which the delegated edge is valid. For example, the edge may apply to emergency identity, family guardian recovery, institutional credential confirmation, local terminal access, or domain service validation.

By encoding delegation as a graph edge rather than a separate manual exception, the system provides a unified mechanism for access, recovery, inheritance, revocation, and audit.

The data structures used for delegation token structure may include identifiers, source and target fields, trust weights, context fields, timestamps, expiration values, signatures, ledger anchor references, revocation states, and policy outputs. These fields provide enablement for concrete processing and are not merely labels for a human trust relationship.

The described arrangements for delegation token structure are compatible with broad functional equivalents. For example, a graph may be stored as adjacency lists, path tables, edge objects, credential relationship maps, tree overlays, mesh overlays, or equivalent structures that preserve node, edge, context, and trust path semantics.

The technical effect of delegation token structure is to improve the reliability and deployability of behavioral identity validation by making the trust state computable, auditable, time-sensitive, locally cacheable, and capable of being synchronized after disconnected operation.

### Delegated Trust Inheritance

Delegated trust inheritance includes the propagation of limited trust from a source node to a recipient node through one or more weighted edges. The system may evaluate whether the recipient can inherit a portion of the source trust state for a specific function, scope, role, and time window.

Family, guardian, medical, institutional, enterprise, and emergency relationships may be represented as delegated edges. These relationships are not assumed to be universally valid; they are evaluated according to scope, time, role, context, revocation state, and path confidence.

For delegated trust inheritance, each described component may be implemented as a software module, local terminal routine, domain node routine, stored data object, signed credential object, graph edge object, or processor-executed step. The implementation may be distributed across devices while retaining a common graph model in which trust is evaluated through signed relationships rather than through a single static identifier.

In one implementation of delegated trust inheritance, the TrustScore Graph Engine receives an input object, identifies relevant nodes and edges, checks timestamps and contexts, verifies signatures or ledger references, selects candidate paths, computes or updates a confidence value, and returns a validation result suitable for a local service, domain portal, or institutional access environment.

In another implementation of delegated trust inheritance, the engine operates in a reduced local mode using a cached subgraph. The local mode is configured to permit only time-limited, scope-limited, or policy-limited identity functions until synchronization with a peer node, domain node, or ActionLedger becomes available.

### Delegated Trust Inheritance—Continued

Inheritance paths may be visualized as a tree or dependency graph while remaining stored internally as graph objects. The visualization is optional and does not limit the underlying data structure.

Automatic expiration or revocation can sever or down-weight a delegated edge. For example, a delegation may end after an expiration time, after a triggering ActionLedger event, after a revocation signal, or after a behavioral anomaly indicates that the trust state should be revalidated.

The data structures used for delegated trust inheritance may include identifiers, source and target fields, trust weights, context fields, timestamps, expiration values, signatures, ledger anchor references, revocation states, and policy outputs. These fields provide enablement for concrete processing and are not merely labels for a human trust relationship.

The described arrangements for delegated trust inheritance are compatible with broad functional equivalents. For example, a graph may be stored as adjacency lists, path tables, edge objects, credential relationship maps, tree overlays, mesh overlays, or equivalent structures that preserve node, edge, context, and trust path semantics.

The technical effect of delegated trust inheritance is to improve the reliability and deployability of behavioral identity validation by making the trust state computable, auditable, time-sensitive, locally cacheable, and capable of being synchronized after disconnected operation.

### Revocation and Rollback State

Revocation state may be associated with a node, trust edge, delegation token, ActionLedger receipt, local snapshot, or validation result. A revoked object may be excluded from path evaluation or may require additional verification before being used.

Rollback state may be maintained as a record of a prior trust assertion, access decision, or synchronization event being reversed, corrected, or superseded. Rollback in this context refers to trust-state correction and audit consistency rather than any specific financial transaction reversal mechanism.

For revocation and rollback state, each described component may be implemented as a software module, local terminal routine, domain node routine, stored data object, signed credential object, graph edge object, or processor-executed step. The implementation may be distributed across devices while retaining a common graph model in which trust is evaluated through signed relationships rather than through a single static identifier.

In one implementation of revocation and rollback state, the TrustScore Graph Engine receives an input object, identifies relevant nodes and edges, checks timestamps and contexts, verifies signatures or ledger references, selects candidate paths, computes or updates a confidence value, and returns a validation result suitable for a local service, domain portal, or institutional access environment.

In another implementation of revocation and rollback state, the engine operates in a reduced local mode using a cached subgraph. The local mode is configured to permit only time-limited, scope-limited, or policy-limited identity functions until synchronization with a peer node, domain node, or ActionLedger becomes available.

### Revocation and Rollback State—Continued

When a local terminal is offline, revocation information may be limited to the last synchronized status. The engine may therefore apply time windows, conservative thresholds, or limited permissions to reduce risks associated with stale revocation information.

Upon reconnection, revocation and rollback states may be synchronized with the ActionLedger or domain node so that offline decisions can be audited and, if necessary, corrected.

The data structures used for revocation and rollback state may include identifiers, source and target fields, trust weights, context fields, timestamps, expiration values, signatures, ledger anchor references, revocation states, and policy outputs. These fields provide enablement for concrete processing and are not merely labels for a human trust relationship.

The described arrangements for revocation and rollback state are compatible with broad functional equivalents. For example, a graph may be stored as adjacency lists, path tables, edge objects, credential relationship maps, tree overlays, mesh overlays, or equivalent structures that preserve node, edge, context, and trust path semantics.

The technical effect of revocation and rollback state is to improve the reliability and deployability of behavioral identity validation by making the trust state computable, auditable, time-sensitive, locally cacheable, and capable of being synchronized after disconnected operation.

### Progressive Disclosure and Privacy

The TrustScore Graph Engine may support progressive disclosure of trust levels depending on requestor privilege. A verifier may receive a validation result without receiving the full graph, all behavior events, or unrelated trust edges.

A trust path may be selectively encrypted, masked, summarized, or represented by a proof object. The verifier may learn that a threshold was satisfied for a particular scope without learning private family, medical, institutional, or behavioral details beyond what is necessary.

For progressive disclosure and privacy, each described component may be implemented as a software module, local terminal routine, domain node routine, stored data object, signed credential object, graph edge object, or processor-executed step. The implementation may be distributed across devices while retaining a common graph model in which trust is evaluated through signed relationships rather than through a single static identifier.

In one implementation of progressive disclosure and privacy, the TrustScore Graph Engine receives an input object, identifies relevant nodes and edges, checks timestamps and contexts, verifies signatures or ledger references, selects candidate paths, computes or updates a confidence value, and returns a validation result suitable for a local service, domain portal, or institutional access environment.

In another implementation of progressive disclosure and privacy, the engine operates in a reduced local mode using a cached subgraph. The local mode is configured to permit only time-limited, scope-limited, or policy-limited identity functions until synchronization with a peer node, domain node, or ActionLedger becomes available.

### Progressive Disclosure and Privacy—Continued

Progressive disclosure is particularly useful for domain portals, emergency terminals, institutional access, and third-party queries in which the verifier needs assurance but not the entire history of a BEI-ID.

The system may therefore provide privacy-preserving queries while still preserving auditability through ActionLedger anchors and signed trust-state objects.

The data structures used for progressive disclosure and privacy may include identifiers, source and target fields, trust weights, context fields, timestamps, expiration values, signatures, ledger anchor references, revocation states, and policy outputs. These fields provide enablement for concrete processing and are not merely labels for a human trust relationship.

The described arrangements for progressive disclosure and privacy are compatible with broad functional equivalents. For example, a graph may be stored as adjacency lists, path tables, edge objects, credential relationship maps, tree overlays, mesh overlays, or equivalent structures that preserve node, edge, context, and trust path semantics.

The technical effect of progressive disclosure and privacy is to improve the reliability and deployability of behavioral identity validation by making the trust state computable, auditable, time-sensitive, locally cacheable, and capable of being synchronized after disconnected operation.

### Proximity and Device Metadata

A trust edge or behavior event may include physical proximity metadata, co-location indicators, relative device signal strength, terminal status, device authentication status, or similar device-context evidence. Such evidence can improve the quality of local trust computation.

For example, an emergency terminal may treat a signed edge supported by recent proximity and local device context differently from an edge that is old, remote, or unsupported by device presence.

For proximity and device metadata, each described component may be implemented as a software module, local terminal routine, domain node routine, stored data object, signed credential object, graph edge object, or processor-executed step. The implementation may be distributed across devices while retaining a common graph model in which trust is evaluated through signed relationships rather than through a single static identifier.

In one implementation of proximity and device metadata, the TrustScore Graph Engine receives an input object, identifies relevant nodes and edges, checks timestamps and contexts, verifies signatures or ledger references, selects candidate paths, computes or updates a confidence value, and returns a validation result suitable for a local service, domain portal, or institutional access environment.

In another implementation of proximity and device metadata, the engine operates in a reduced local mode using a cached subgraph. The local mode is configured to permit only time-limited, scope-limited, or policy-limited identity functions until synchronization with a peer node, domain node, or ActionLedger becomes available.

### Proximity and Device Metadata—Continued

Proximity metadata may be stored directly on the edge, associated with a behavior event node, or stored as a context overlay. The engine may apply the metadata only for scopes for which proximity is relevant.

Using proximity and device metadata helps distinguish live contextual trust from old or merely asserted relationships.

The data structures used for proximity and device metadata may include identifiers, source and target fields, trust weights, context fields, timestamps, expiration values, signatures, ledger anchor references, revocation states, and policy outputs. These fields provide enablement for concrete processing and are not merely labels for a human trust relationship.

The described arrangements for proximity and device metadata are compatible with broad functional equivalents. For example, a graph may be stored as adjacency lists, path tables, edge objects, credential relationship maps, tree overlays, mesh overlays, or equivalent structures that preserve node, edge, context, and trust path semantics.

The technical effect of proximity and device metadata is to improve the reliability and deployability of behavioral identity validation by making the trust state computable, auditable, time-sensitive, locally cacheable, and capable of being synchronized after disconnected operation.

### Security Against Replay and Stale Trust

The system reduces replay risk by using signed trust edges, timestamps, time windows, ActionLedger anchors, behavior-derived entropy, and revocation state. A captured old edge or token may fail if it is expired, revoked, contextually invalid, or not supported by current path confidence.

Stale trust attacks are mitigated by time-decay weighting, sliding validation windows, snapshot expiration, and synchronization with peer or domain nodes. The system can reduce the influence of old trust assertions instead of treating trust as permanently valid.

For security against replay and stale trust, each described component may be implemented as a software module, local terminal routine, domain node routine, stored data object, signed credential object, graph edge object, or processor-executed step. The implementation may be distributed across devices while retaining a common graph model in which trust is evaluated through signed relationships rather than through a single static identifier.

In one implementation of security against replay and stale trust, the TrustScore Graph Engine receives an input object, identifies relevant nodes and edges, checks timestamps and contexts, verifies signatures or ledger references, selects candidate paths, computes or updates a confidence value, and returns a validation result suitable for a local service, domain portal, or institutional access environment.

In another implementation of security against replay and stale trust, the engine operates in a reduced local mode using a cached subgraph. The local mode is configured to permit only time-limited, scope-limited, or policy-limited identity functions until synchronization with a peer node, domain node, or ActionLedger becomes available.

### Security Against Replay and Stale Trust—Continued

Behavioral entropy and device context may provide liveness-related evidence. Such evidence need not be perfect; it provides an additional technical signal that can be combined with ledger anchoring, signatures, and context filtering.

The combined use of graph topology, signatures, time windows, ledger anchoring, local snapshot restrictions, and threshold policies provides a layered security architecture for decentralized identity validation.

The data structures used for security against replay and stale trust may include identifiers, source and target fields, trust weights, context fields, timestamps, expiration values, signatures, ledger anchor references, revocation states, and policy outputs. These fields provide enablement for concrete processing and are not merely labels for a human trust relationship.

The described arrangements for security against replay and stale trust are compatible with broad functional equivalents. For example, a graph may be stored as adjacency lists, path tables, edge objects, credential relationship maps, tree overlays, mesh overlays, or equivalent structures that preserve node, edge, context, and trust path semantics.

The technical effect of security against replay and stale trust is to improve the reliability and deployability of behavioral identity validation by making the trust state computable, auditable, time-sensitive, locally cacheable, and capable of being synchronized after disconnected operation.

### Risk-Adaptive Access Control

The TrustScore Graph Engine may use risk-adaptive thresholds so that different operations require different confidence levels. Routine low-risk access may require a lower threshold than account recovery, delegated authority, emergency access, institutional certification, or domain-level administrative action.

When the computed confidence is intermediate, the engine may require step-up verification, additional signature confirmation, a fresh ActionLedger check, local device confirmation, or manual review by an authorized terminal or institution.

For risk-adaptive access control, each described component may be implemented as a software module, local terminal routine, domain node routine, stored data object, signed credential object, graph edge object, or processor-executed step. The implementation may be distributed across devices while retaining a common graph model in which trust is evaluated through signed relationships rather than through a single static identifier.

In one implementation of risk-adaptive access control, the TrustScore Graph Engine receives an input object, identifies relevant nodes and edges, checks timestamps and contexts, verifies signatures or ledger references, selects candidate paths, computes or updates a confidence value, and returns a validation result suitable for a local service, domain portal, or institutional access environment.

In another implementation of risk-adaptive access control, the engine operates in a reduced local mode using a cached subgraph. The local mode is configured to permit only time-limited, scope-limited, or policy-limited identity functions until synchronization with a peer node, domain node, or ActionLedger becomes available.

### Risk-Adaptive Access Control-Continued

The system is designed to reduce user friction by allowing normal low-risk operations to proceed with minimal interruption while increasing verification only when risk, context, or path uncertainty requires additional assurance.

This risk-adaptive design improves practical deployability in commercial systems where security must be balanced against false rejection and user burden.

The data structures used for risk-adaptive access control may include identifiers, source and target fields, trust weights, context fields, timestamps, expiration values, signatures, ledger anchor references, revocation states, and policy outputs. These fields provide enablement for concrete processing and are not merely labels for a human trust relationship.

The described arrangements for risk-adaptive access control are compatible with broad functional equivalents. For example, a graph may be stored as adjacency lists, path tables, edge objects, credential relationship maps, tree overlays, mesh overlays, or equivalent structures that preserve node, edge, context, and trust path semantics.

The technical effect of risk-adaptive access control is to improve the reliability and deployability of behavioral identity validation by making the trust state computable, auditable, time-sensitive, locally cacheable, and capable of being synchronized after disconnected operation.

### Emergency Identity Recovery Embodiment

In an emergency identity recovery embodiment, a local terminal receives a request to validate a BEI-ID when a central server or network is unavailable. The terminal reads an offline trust graph snapshot from a local KeyCache, SIM element, NFC module, or browser key agent.

The terminal verifies signed edges, checks time windows, applies revocation information, evaluates a trust path to the target BEI-ID, and determines whether an emergency threshold is satisfied. If so, the terminal may permit a limited identity function such as identity confirmation or emergency contact retrieval.

For emergency identity recovery embodiment, each described component may be implemented as a software module, local terminal routine, domain node routine, stored data object, signed credential object, graph edge object, or processor-executed step. The implementation may be distributed across devices while retaining a common graph model in which trust is evaluated through signed relationships rather than through a single static identifier.

In one implementation of emergency identity recovery embodiment, the TrustScore Graph Engine receives an input object, identifies relevant nodes and edges, checks timestamps and contexts, verifies signatures or ledger references, selects candidate paths, computes or updates a confidence value, and returns a validation result suitable for a local service, domain portal, or institutional access environment.

In another implementation of emergency identity recovery embodiment, the engine operates in a reduced local mode using a cached subgraph. The local mode is configured to permit only time-limited, scope-limited, or policy-limited identity functions until synchronization with a peer node, domain node, or ActionLedger becomes available.

### Emergency Identity Recovery Embodiment—Continued

The emergency access is limited in scope and time. It may not permit unrelated high-risk actions, and it may generate a local receipt for later ActionLedger synchronization.

This embodiment illustrates that the invention provides technical resilience for disconnected conditions without requiring unlimited offline authority.

The data structures used for emergency identity recovery embodiment may include identifiers, source and target fields, trust weights, context fields, timestamps, expiration values, signatures, ledger anchor references, revocation states, and policy outputs. These fields provide enablement for concrete processing and are not merely labels for a human trust relationship.

The described arrangements for emergency identity recovery embodiment are compatible with broad functional equivalents. For example, a graph may be stored as adjacency lists, path tables, edge objects, credential relationship maps, tree overlays, mesh overlays, or equivalent structures that preserve node, edge, context, and trust path semantics.

The technical effect of emergency identity recovery embodiment is to improve the reliability and deployability of behavioral identity validation by making the trust state computable, auditable, time-sensitive, locally cacheable, and capable of being synchronized after disconnected operation.

### Family and Guardian Embodiment

In a family or guardian embodiment, a parent, guardian, or caregiver BEI-ID creates a signed delegation token for a child, elder, patient, or dependent recipient BEI-ID. The token defines the permitted scope, role, duration, and context of the delegation.

The TrustScore Graph Engine maps the token into a weighted delegated edge and evaluates whether the recipient can inherit trust for a requested function. The function may be identity recovery, school pickup confirmation, medical emergency disclosure, or limited local service access.

For family and guardian embodiment, each described component may be implemented as a software module, local terminal routine, domain node routine, stored data object, signed credential object, graph edge object, or processor-executed step. The implementation may be distributed across devices while retaining a common graph model in which trust is evaluated through signed relationships rather than through a single static identifier.

In one implementation of family and guardian embodiment, the TrustScore Graph Engine receives an input object, identifies relevant nodes and edges, checks timestamps and contexts, verifies signatures or ledger references, selects candidate paths, computes or updates a confidence value, and returns a validation result suitable for a local service, domain portal, or institutional access environment.

In another implementation of family and guardian embodiment, the engine operates in a reduced local mode using a cached subgraph. The local mode is configured to permit only time-limited, scope-limited, or policy-limited identity functions until synchronization with a peer node, domain node, or ActionLedger becomes available.

### Family and Guardian Embodiment—Continued

The delegated edge may expire automatically or be revoked by a ledger event. Multiple guardians may provide overlapping edges, and the engine may compute a composite confidence score based on the available paths.

This embodiment shows how social and family relationships can be represented as technical graph objects rather than informal account recovery contacts.

The data structures used for family and guardian embodiment may include identifiers, source and target fields, trust weights, context fields, timestamps, expiration values, signatures, ledger anchor references, revocation states, and policy outputs. These fields provide enablement for concrete processing and are not merely labels for a human trust relationship.

The described arrangements for family and guardian embodiment are compatible with broad functional equivalents. For example, a graph may be stored as adjacency lists, path tables, edge objects, credential relationship maps, tree overlays, mesh overlays, or equivalent structures that preserve node, edge, context, and trust path semantics.

The technical effect of family and guardian embodiment is to improve the reliability and deployability of behavioral identity validation by making the trust state computable, auditable, time-sensitive, locally cacheable, and capable of being synchronized after disconnected operation.

### Institutional Credential Embodiment

In an institutional embodiment, a doctor, hospital, school, enterprise, agency, or service provider acts as an institution node or domain node. The institution may issue a signed trust assertion to a member, employee, practitioner, patient, student, or service recipient BEI-ID.

The assertion is stored as a directed trust edge with scope, role, time, and ledger anchor. A terminal can later evaluate whether the asserted role remains valid for a requested operation.

For institutional credential embodiment, each described component may be implemented as a software module, local terminal routine, domain node routine, stored data object, signed credential object, graph edge object, or processor-executed step. The implementation may be distributed across devices while retaining a common graph model in which trust is evaluated through signed relationships rather than through a single static identifier.

In one implementation of institutional credential embodiment, the TrustScore Graph Engine receives an input object, identifies relevant nodes and edges, checks timestamps and contexts, verifies signatures or ledger references, selects candidate paths, computes or updates a confidence value, and returns a validation result suitable for a local service, domain portal, or institutional access environment.

In another implementation of institutional credential embodiment, the engine operates in a reduced local mode using a cached subgraph. The local mode is configured to permit only time-limited, scope-limited, or policy-limited identity functions until synchronization with a peer node, domain node, or ActionLedger becomes available.

### Institutional Credential Embodiment—Continued

The same graph engine can evaluate whether a doctor has limited emergency authority, whether an employee has access to an institutional service, or whether a credential should be treated as stale pending renewed verification.

This embodiment supports commercial deployment because it maps real institutional relationships into interoperable trust edges and validation results.

The data structures used for institutional credential embodiment may include identifiers, source and target fields, trust weights, context fields, timestamps, expiration values, signatures, ledger anchor references, revocation states, and policy outputs. These fields provide enablement for concrete processing and are not merely labels for a human trust relationship.

The described arrangements for institutional credential embodiment are compatible with broad functional equivalents. For example, a graph may be stored as adjacency lists, path tables, edge objects, credential relationship maps, tree overlays, mesh overlays, or equivalent structures that preserve node, edge, context, and trust path semantics.

The technical effect of institutional credential embodiment is to improve the reliability and deployability of behavioral identity validation by making the trust state computable, auditable, time-sensitive, locally cacheable, and capable of being synchronized after disconnected operation.

### Domain Portal Verification Embodiment

A domain portal embodiment allows a verifier to submit a BEI-ID, trust token, or signed request to a domain-integrated verification node. The domain node evaluates trust paths, ActionLedger anchors, revocation status, and context-specific thresholds.

The domain portal may return a validation result without disclosing the full graph. For example, it may return that the requested scope is valid, expired, denied, limited, or requires step-up verification.

For domain portal verification embodiment, each described component may be implemented as a software module, local terminal routine, domain node routine, stored data object, signed credential object, graph edge object, or processor-executed step. The implementation may be distributed across devices while retaining a common graph model in which trust is evaluated through signed relationships rather than through a single static identifier.

In one implementation of domain portal verification embodiment, the TrustScore Graph Engine receives an input object, identifies relevant nodes and edges, checks timestamps and contexts, verifies signatures or ledger references, selects candidate paths, computes or updates a confidence value, and returns a validation result suitable for a local service, domain portal, or institutional access environment.

In another implementation of domain portal verification embodiment, the engine operates in a reduced local mode using a cached subgraph. The local mode is configured to permit only time-limited, scope-limited, or policy-limited identity functions until synchronization with a peer node, domain node, or ActionLedger becomes available.

### Domain Portal Verification Embodiment—Continued

Domain portals may provide a convenient licensing and deployment model because existing identity, banking, medical, enterprise, browser, or government service systems can call the verification interface without replacing their entire infrastructure.

The domain portal embodiment therefore supports commercialization while preserving the core technical requirement that the decision be based on signed graph relationships and trust path computation.

The data structures used for domain portal verification embodiment may include identifiers, source and target fields, trust weights, context fields, timestamps, expiration values, signatures, ledger anchor references, revocation states, and policy outputs. These fields provide enablement for concrete processing and are not merely labels for a human trust relationship.

The described arrangements for domain portal verification embodiment are compatible with broad functional equivalents. For example, a graph may be stored as adjacency lists, path tables, edge objects, credential relationship maps, tree overlays, mesh overlays, or equivalent structures that preserve node, edge, context, and trust path semantics.

The technical effect of domain portal verification embodiment is to improve the reliability and deployability of behavioral identity validation by making the trust state computable, auditable, time-sensitive, locally cacheable, and capable of being synchronized after disconnected operation.

### Disconnected Community Embodiment

In a disconnected community embodiment, multiple local terminals maintain limited trust graph snapshots and exchange updates by peer-to-peer synchronization. Each terminal may validate only the subset of the graph that is relevant to local identity, emergency, access, or service functions.

When the network is restored, terminals submit local receipts, trust decisions, and updated edge states to a domain node or ActionLedger. Conflicts or stale objects can be resolved according to timestamps, signatures, revocation state, and confidence thresholds.

For disconnected community embodiment, each described component may be implemented as a software module, local terminal routine, domain node routine, stored data object, signed credential object, graph edge object, or processor-executed step. The implementation may be distributed across devices while retaining a common graph model in which trust is evaluated through signed relationships rather than through a single static identifier.

In one implementation of disconnected community embodiment, the TrustScore Graph Engine receives an input object, identifies relevant nodes and edges, checks timestamps and contexts, verifies signatures or ledger references, selects candidate paths, computes or updates a confidence value, and returns a validation result suitable for a local service, domain portal, or institutional access environment.

In another implementation of disconnected community embodiment, the engine operates in a reduced local mode using a cached subgraph. The local mode is configured to permit only time-limited, scope-limited, or policy-limited identity functions until synchronization with a peer node, domain node, or ActionLedger becomes available.

### Disconnected Community Embodiment—Continued

This embodiment is useful where central infrastructure is temporarily unavailable, where communities operate at network edges, or where local resilience is required.

The embodiment demonstrates how the same TrustScore graph model supports both global synchronization and local autonomy.

The data structures used for disconnected community embodiment may include identifiers, source and target fields, trust weights, context fields, timestamps, expiration values, signatures, ledger anchor references, revocation states, and policy outputs. These fields provide enablement for concrete processing and are not merely labels for a human trust relationship.

The described arrangements for disconnected community embodiment are compatible with broad functional equivalents. For example, a graph may be stored as adjacency lists, path tables, edge objects, credential relationship maps, tree overlays, mesh overlays, or equivalent structures that preserve node, edge, context, and trust path semantics.

The technical effect of disconnected community embodiment is to improve the reliability and deployability of behavioral identity validation by making the trust state computable, auditable, time-sensitive, locally cacheable, and capable of being synchronized after disconnected operation.

In a banking or high-risk access embodiment, the TrustScore Graph Engine can operate as a trust decision layer above an existing login, multi-factor authentication, KYC, or account-control system. The engine need not replace those systems; it evaluates whether behavior, device, delegation, ledger, time, and context collectively support the requested operation.

A routine low-risk request may require only a lower TrustScore threshold. A request involving account recovery, addition of a new delegated actor, modification of core identity settings, institutional approval, high-risk terminal access, or other sensitive operation may require a higher threshold, ActionLedger-backed path verification, recent time evidence, or step-up validation.

The validation result may be allow, deny, limited, delayed, step-up required, manual review required, or temporary local authorization. This result structure permits deployment in regulated or high-security environments while reducing false denial in ordinary low-risk use.

In financial, banking, enterprise, medical, government, and emergency services, the engine may return a decision and reason code without exposing full identity graph details. This supports privacy-preserving integration and avoids unnecessary disclosure of behavior or family relationships to external service providers.

The high-risk access embodiment is limited to the technical trust decision layer. It does not require a new financial transfer protocol, currency minting system, or transaction rollback mechanism. Such external systems may consume the engine result as one input to their own policy engines.

The same architecture can be licensed or deployed by third parties as a plug-in trust service, domain verification node, SDK, browser agent, terminal component, or institutional identity middleware. This preserves asset value without narrowing the invention to one industry or one user interface.

The technical effect of this embodiment is to reduce account-takeover risk, stale-credential reliance, and unauthorized delegated access while allowing normal users to proceed with low friction under routine circumstances.

### Banking and High-Risk Access Embodiment—Continued

The disclosed embodiment does not require a specific financial rollback protocol. It provides trust validation, authorization confidence, revocation awareness, audit receipts, and risk-adaptive access decisions that can be integrated into existing financial or institutional systems.

This embodiment helps position the invention for licensing while keeping the claimed invention focused on graph-based behavioral identity validation.

The data structures used for banking and high-risk access embodiment may include identifiers, source and target fields, trust weights, context fields, timestamps, expiration values, signatures, ledger anchor references, revocation states, and policy outputs. These fields provide enablement for concrete processing and are not merely labels for a human trust relationship.

The described arrangements for banking and high-risk access embodiment are compatible with broad functional equivalents. For example, a graph may be stored as adjacency lists, path tables, edge objects, credential relationship maps, tree overlays, mesh overlays, or equivalent structures that preserve node, edge, context, and trust path semantics.

The technical effect of banking and high-risk access embodiment is to improve the reliability and deployability of behavioral identity validation by making the trust state computable, auditable, time-sensitive, locally cacheable, and capable of being synchronized after disconnected operation.

### International Deployment and Interfaces

The TrustScore Graph Engine may be deployed in systems that require interoperability across institutions, countries, platforms, browsers, terminals, devices, and domain portals. Interoperability is supported by using signed objects, public-key verifiable signatures, timestamped ledger anchors, and documented validation result objects.

The system may be integrated beside existing authentication, identity governance, access-control, credential, or audit systems. It need not replace existing infrastructure; rather, it may add a graph-based behavioral trust decision layer.

For international deployment and interfaces, each described component may be implemented as a software module, local terminal routine, domain node routine, stored data object, signed credential object, graph edge object, or processor-executed step. The implementation may be distributed across devices while retaining a common graph model in which trust is evaluated through signed relationships rather than through a single static identifier.

In one implementation of international deployment and interfaces, the TrustScore Graph Engine receives an input object, identifies relevant nodes and edges, checks timestamps and contexts, verifies signatures or ledger references, selects candidate paths, computes or updates a confidence value, and returns a validation result suitable for a local service, domain portal, or institutional access environment.

In another implementation of international deployment and interfaces, the engine operates in a reduced local mode using a cached subgraph. The local mode is configured to permit only time-limited, scope-limited, or policy-limited identity functions until synchronization with a peer node, domain node, or ActionLedger becomes available.

The system can be aligned with international identity and security practices by treating external credentials, decentralized identifiers, verifiable credentials, device confirmations, institutional attestations, and audit records as possible graph inputs rather than as replacements for the graph engine.

The TrustScore Graph Engine may translate those external inputs into nodes, edges, contexts, ledger anchors, or validation result fields. A conventional credential may become an institution edge; a device confirmation may become a device-context indicator; a signed audit record may become a ledger anchor; and a delegated credential may become a scoped weighted edge.

This mapping allows a deployment to interoperate with existing standards while still practicing the invention by computing access authority through graph traversal, time-decay, behavioral entropy, offline snapshot policy, and delegated trust path evaluation.

The invention therefore provides a bridge between existing international identity standards and BEI behavioral identity infrastructure. The bridge is technical: it defines object mappings, local and domain validation operations, synchronization, and privacy-preserving disclosure levels.

The system may support implementation profiles for enterprise IAM, government identity, medical credentialing, emergency access, family delegation, domain-portal verification, and local offline terminal use. Each profile may have different thresholds but shares the same core graph engine.

Such standard alignment increases the practical utility of the invention and improves the ability of a potential licensee or assignee to integrate the patented system into existing products.

The technical effect of international deployment and interfaces is to make the invention useful in real systems that must interoperate across borders, institutions, devices, and domains without losing the core TrustScore path-computation model.

### Technical Effects

The disclosed system improves decentralized identity verification by converting identity trust from a static credential into a signed, time-sensitive, context-aware, graph-computable state.

The disclosed offline snapshot mechanism improves the operation of local terminals by allowing limited validation when network connectivity is unavailable, while preserving freshness limits, revocation checks, and later synchronization.

For technical effects, each described component may be implemented as a software module, local terminal routine, domain node routine, stored data object, signed credential object, graph edge object, or processor-executed step. The implementation may be distributed across devices while retaining a common graph model in which trust is evaluated through signed relationships rather than through a single static identifier.

In one implementation of technical effects, the TrustScore Graph Engine receives an input object, identifies relevant nodes and edges, checks timestamps and contexts, verifies signatures or ledger references, selects candidate paths, computes or updates a confidence value, and returns a validation result suitable for a local service, domain portal, or institutional access environment.

In another implementation of technical effects, the engine operates in a reduced local mode using a cached subgraph. The local mode is configured to permit only time-limited, scope-limited, or policy-limited identity functions until synchronization with a peer node, domain node, or ActionLedger becomes available.

### Technical Effects—Continued

The disclosed delegation edge mechanism improves delegated access by encoding scope, time, role, and revocation constraints in a graph object evaluated by a common engine.

The disclosed entropy and temporal trust factors improve trust computation by weighting trust based on behavior-derived evidence and time freshness rather than relying solely on static social or credential relationships.

The data structures used for technical effects may include identifiers, source and target fields, trust weights, context fields, timestamps, expiration values, signatures, ledger anchor references, revocation states, and policy outputs. These fields provide enablement for concrete processing and are not merely labels for a human trust relationship.

The described arrangements for technical effects are compatible with broad functional equivalents. For example, a graph may be stored as adjacency lists, path tables, edge objects, credential relationship maps, tree overlays, mesh overlays, or equivalent structures that preserve node, edge, context, and trust path semantics.

The technical effect of technical effects is to improve the reliability and deployability of behavioral identity validation by making the trust state computable, auditable, time-sensitive, locally cacheable, and capable of being synchronized after disconnected operation.

### Industrial Applicability

The invention may be used in identity platforms, access control systems, domain verification portals, mobile terminals, browser agents, SIM or NFC-based identity modules, emergency identity recovery systems, institutional credential systems, family or guardian delegation systems, and high-risk service authorization systems.

The system can be packaged as a software component, terminal module, domain verification service, local offline validation module, institutional API, or graph engine integrated with existing identity and access management infrastructure.

For industrial applicability, each described component may be implemented as a software module, local terminal routine, domain node routine, stored data object, signed credential object, graph edge object, or processor-executed step. The implementation may be distributed across devices while retaining a common graph model in which trust is evaluated through signed relationships rather than through a single static identifier.

In one implementation of industrial applicability, the TrustScore Graph Engine receives an input object, identifies relevant nodes and edges, checks timestamps and contexts, verifies signatures or ledger references, selects candidate paths, computes or updates a confidence value, and returns a validation result suitable for a local service, domain portal, or institutional access environment.

In another implementation of industrial applicability, the engine operates in a reduced local mode using a cached subgraph. The local mode is configured to permit only time-limited, scope-limited, or policy-limited identity functions until synchronization with a peer node, domain node, or ActionLedger becomes available.

### Industrial Applicability—Continued

For asset-package purposes, the invention provides a trust decision infrastructure layer that can interoperate with domain assets, ActionLedger assets, terminal assets, behavioral signal assets, and related BEI identity infrastructure without requiring the formal patent document to include valuation claims.

The invention therefore provides a practical, technically grounded foundation for licensing discussions while remaining directed to specific structures and methods of graph-based behavioral identity verification.

The data structures used for industrial applicability may include identifiers, source and target fields, trust weights, context fields, timestamps, expiration values, signatures, ledger anchor references, revocation states, and policy outputs. These fields provide enablement for concrete processing and are not merely labels for a human trust relationship.

The described arrangements for industrial applicability are compatible with broad functional equivalents. For example, a graph may be stored as adjacency lists, path tables, edge objects, credential relationship maps, tree overlays, mesh overlays, or equivalent structures that preserve node, edge, context, and trust path semantics.

The technical effect of industrial applicability is to improve the reliability and deployability of behavioral identity validation by making the trust state computable, auditable, time-sensitive, locally cacheable, and capable of being synchronized after disconnected operation.

### Conclusion

The foregoing embodiments describe a TrustScore Graph Engine that represents behavioral identity and behavioral events as nodes, represents trust assertions as signed directed edges, anchors state to ActionLedger records, stores restricted offline snapshots, and evaluates trust paths for access, recovery, delegation, and local identity functions.

The invention is not limited to the examples described. Equivalent functional structures, alternative graph representations, different endpoint memories, different domain interfaces, and different trust scoring formulas may be used while preserving the core technical relationship among nodes, edges, ledger anchors, local snapshots, and threshold-based validation.

For conclusion, each described component may be implemented as a software module, local terminal routine, domain node routine, stored data object, signed credential object, graph edge object, or processor-executed step. The implementation may be distributed across devices while retaining a common graph model in which trust is evaluated through signed relationships rather than through a single static identifier.

In one implementation of conclusion, the TrustScore Graph Engine receives an input object, identifies relevant nodes and edges, checks timestamps and contexts, verifies signatures or ledger references, selects candidate paths, computes or updates a confidence value, and returns a validation result suitable for a local service, domain portal, or institutional access environment.

In another implementation of conclusion, the engine operates in a reduced local mode using a cached subgraph. The local mode is configured to permit only time-limited, scope-limited, or policy-limited identity functions until synchronization with a peer node, domain node, or ActionLedger becomes available.

### Conclusion—Continued

The disclosed system provides a technical solution to the problem of dynamic behavioral identity verification across online, offline, delegated, and domain-integrated contexts.

Accordingly, the invention establishes a practical trust computation and propagation layer for Behavioral Economic Identity (BEI) trust infrastructure.

The data structures used for conclusion may include identifiers, source and target fields, trust weights, context fields, timestamps, expiration values, signatures, ledger anchor references, revocation states, and policy outputs. These fields provide enablement for concrete processing and are not merely labels for a human trust relationship.

The described arrangements for conclusion are compatible with broad functional equivalents. For example, a graph may be stored as adjacency lists, path tables, edge objects, credential relationship maps, tree overlays, mesh overlays, or equivalent structures that preserve node, edge, context, and trust path semantics.

The technical effect of conclusion is to improve the reliability and deployability of behavioral identity validation by making the trust state computable, auditable, time-sensitive, locally cacheable, and capable of being synchronized after disconnected operation.

### Representative Validation Result Object

The validation result object may include a request identifier, target node identifier, evaluated scope, computed trust path confidence value, threshold value, result category, expiration information, ledger receipt reference, and any step-up or manual review instruction.

The result category may include allow, deny, limited access, temporary access, delayed access, step-up verification, manual review, local offline grant, or synchronization pending. These categories allow an implementer to integrate the engine into existing systems without making trust computation visible to an end user.

The validation result object may omit private graph details while retaining enough information for audit. For example, a verifier may receive that a path satisfied an emergency threshold, while the identity subject preserves the underlying family or medical trust path from disclosure.

The validation result object may be stored in a terminal, transmitted to a domain node, attached to an ActionLedger receipt, or cached for later reconciliation after offline operation.

This object-oriented output improves interoperability and provides a concrete interface for licensing, deployment, and integration into identity, access-control, financial, institutional, browser, terminal, and domain-portal systems.

### Representative Node and Edge Object Schema

A representative node object may include a node identifier, node type, role, domain identifier, institutional association, public verification key, status, creation timestamp, last validation timestamp, and optional context overlay identifiers.

A representative directed edge object may include a source node identifier, target node identifier, edge type, TrustScore value, timestamp, expiration time, scope, verification context, signature data, ActionLedger anchor, revocation state, and entropy or temporal freshness metadata.

The node object and edge object may be stored in a graph database, local cache, signed credential store, terminal memory, portable memory, or domain service repository. The storage format may vary provided that the fields remain available to the TrustScore Graph Engine.

When the engine runs offline, a reduced schema may be used to store only fields required for limited local validation. When the engine runs online, the full schema may be synchronized or verified against ActionLedger state.

These schemas provide concrete implementation support for the claims while allowing equivalent technical data structures to be used by different vendors or standards environments.

### Representative API Operations

A representative API may include operations for registering a node, forming a directed trust edge, anchoring a behavior event, issuing a delegation token, generating an offline snapshot, evaluating a trust path, updating revocation status, and synchronizing an offline receipt.

Each API operation may require signed inputs and may return a validation result, ledger receipt, snapshot object, revocation confirmation, or synchronization status. This allows the TrustScore graph layer to be integrated with existing identity services without replacing the surrounding service platform.

The API may be implemented locally, through a domain node, through a peer-to-peer channel, through a browser agent, or through a server endpoint. The transport is not limiting, because the invention resides in the signed graph objects and validation process.

API operations may support field-of-use licensing because the same trust graph engine can be embedded in financial access, medical access, enterprise access, government service, domain portal, or emergency identity environments.

This implementation detail provides a practical bridge from patent disclosure to commercial deployment while remaining focused on the graph-based behavioral trust validation invention.

### False Denial Mitigation and User Recovery

The system may mitigate false denial by separating identity confidence from permission scope. A low or incomplete trust path need not result in permanent exclusion; instead, the engine may provide limited access, read-only access, temporary access, or an additional verification request.

When a normal user is on a new device or in an unusual context, the engine may raise the threshold, request a fresh trust edge, verify a recent ActionLedger receipt, or require step-up confirmation through a trusted terminal or domain node.

When the requested operation is high-risk, the engine may delay the operation, route it for manual review, or require a second trust path, while still permitting low-risk functions such as viewing basic identity status or initiating recovery.

This progressive design reduces user frustration and improves deployability by avoiding a system that simply locks out legitimate users whenever a single signal is missing.

False denial mitigation is therefore a technical access-control output of the TrustScore Graph Engine and not merely a customer service feature.

### Field-of-Use Deployment Examples

The same TrustScore graph structure may be deployed in different fields of use by changing thresholds, scopes, context overlays, and terminal policies. The underlying node, edge, snapshot, and ledger anchor architecture remains consistent across fields.

In a healthcare setting, the engine may emphasize emergency scope, guardian delegation, institutional credential edges, and progressive disclosure. In an enterprise setting, the engine may emphasize role identifiers, device context, and revocation state.

In a financial or high-risk service setting, the engine may emphasize device trust, recency, multiple trust paths, ActionLedger receipts, and risk-adaptive thresholds, while leaving final transaction processing to the surrounding financial system.

In a government or public-service setting, the engine may support local identity confirmation, disaster recovery, institutional authorization, and auditability without requiring every terminal to access a central database in real time.

These field-of-use examples support asset-package integration and licensing while staying within the technical framework of graph-based behavioral identity verification.

The boundary of this application is the TrustScore Graph Engine for behavioral identity verification, offline delegated trust validation, and delegated trust inheritance. The specification intentionally keeps TimeCurrency issuance, financial rollback protocols, and PUF/TEE hardware-root inventions outside the core claim scope of this application unless recited only as external systems that may consume a validation result.

This boundary preserves no-new-matter discipline and helps the claims remain directed to the original disclosed trust graph engine. Related BEI portfolio inventions may interoperate with the graph engine, but this application focuses on graph nodes, signed trust edges, ActionLedger anchoring, Silent Echo behavioral entropy, temporal trust factors, offline KeyCache validation, delegated edges, and threshold access decisions.

The specification uses broad functional language to prevent avoidance by superficial re-naming while still remaining within the original technical core. Alternative labels, object formats, transport protocols, and storage structures do not avoid the invention when they perform the same graph-based behavioral trust computation.

The portfolio-compatible boundary also improves transaction and licensing readiness. A potential licensee can take this patent as the trust-decision layer and combine it with separate BEI domain, time, hardware-root, or financial-recovery technologies under separate licenses or continuation filings.

The patent therefore provides both narrow technical implementations and broad system-level coverage: the claims can read on concrete local caches, signed edges, ledger receipts, and delegation tokens while the specification supports equivalent graph stores, trust weights, proof objects, domain nodes, and interface mappings.

This layered approach creates practical protection against design-around attempts that merely change terminology, storage format, transport, scoring label, or deployment surface while still using behavior-linked identity nodes, time-bound trust edges, ledger anchoring, offline snapshots, and delegated path computation.

What is claimed is:

1. A system for graph-based behavioral identity verification and dynamic trust resolution across digital, institutional, and economic networks, comprising: a plurality of nodes including behavioral identity nodes and authenticated behavior event nodes; a plurality of directed trust edges connecting source nodes to target nodes, each directed trust edge storing at least a trust score value, timestamp, verification context, signature information, ledger anchor, and revocation or expiration status; a TrustScore Graph Engine configured to compute direct and transitive path confidence values by traversing the directed trust edges, applying time-decay weighting, behavioral entropy weighting, context overlay filtering, and threshold-based access logic; a local trust cache configured to store a restricted offline trust graph snapshot for local validation when network access is unavailable; an access control module configured to output an allow, deny, limited, delayed, step-up, manual-review, or temporary-local-access result based on a risk-adaptive threshold; and a synchronization module configured to synchronize offline validation receipts, trust-state updates, revocation status, or delegation updates with an ActionLedger, peer node, or domain node after network restoration.

2. A method of validating behavioral identity in an offline environment, comprising: receiving, by a local verification terminal, a target behavioral identity identifier; retrieving, from a local trust cache, a cached trust graph snapshot comprising signed behavioral identity nodes, authenticated behavior event nodes, directed trust edges, timestamps, verification contexts, and revocation status; verifying whether the cached trust graph snapshot is within a predefined validation window; computing, by a local TrustScore Graph Engine, one or more trust paths to the target behavioral identity identifier using time-decay weighting, behavioral entropy weighting, context filtering, and threshold comparison; granting, denying, limiting, delaying, or requiring step-up verification for a local identity function based on the computed trust path confidence; generating an offline validation receipt; and synchronizing the offline validation receipt with a peer node, domain node, or ActionLedger after network restoration.

3. A method of delegated trust inheritance in a behavioral identity graph, comprising: receiving a signed trust delegation token from a source behavioral identity node to a recipient behavioral identity node, the signed trust delegation token including at least a source identifier, recipient identifier, scope parameter, role parameter, time constraint, and revocation condition; verifying the signed trust delegation token; converting the verified trust delegation token into a weighted directed trust edge in the behavioral identity graph; evaluating inherited trust paths that traverse the weighted directed trust edge; resolving whether the recipient behavioral identity node is authorized for a requested identity, access, recovery, or local service function within the scope parameter and time constraint; and automatically expiring, revoking, down-weighting, or synchronizing the weighted directed trust edge upon expiration, revocation, risk signal, or network restoration.

4. The system of claim 1, wherein the TrustScore Graph Engine adjusts the trust score value using a time-decay model applied to an elapsed time associated with the timestamp.

5. The system of claim 1, wherein the TrustScore Graph Engine adjusts the trust score value using behavioral entropy information received from a passive behavioral signal source.

6. The system of claim 1, wherein the signature information for a directed trust edge is generated or verified using key material derived at least in part from behavior-derived entropy.

7. The system of claim 1, wherein the verification context includes at least one of a geographic context, temporal context, institutional context, domain context, device context, proximity context, role context, risk context, or cryptographic proof object showing that a time-window or scope condition is satisfied.

8. The system of claim 1, wherein each behavioral identity node includes a role identifier used to determine whether a requested identity function is within a permitted scope.

9. The system of claim 1, wherein the local trust cache comprises a partitioned local subgraph stored in a terminal memory, secure local storage, mobile device memory, browser key agent, SIM storage, or NFC memory.

10. The method of claim 2, wherein the cached trust graph snapshot is limited to a predefined validation window to reduce stale trust attacks.

11. The method of claim 2, further comprising synchronizing an offline validation receipt, trust state update, or revocation status with a peer node, domain node, or ActionLedger after network restoration.

12. The method of claim 2, wherein retrieving the cached trust graph snapshot comprises retrieving the cached trust graph snapshot from a SIM module, an NFC module, a browser-based key agent, or a portable credential memory.

13. The method of claim 3, wherein the weighted directed trust edge is automatically expired, revoked, severed, or down-weighted upon expiration of the time constraint or upon detection of a triggering behavior event.

14. The method of claim 3, wherein a plurality of signed trust delegation tokens directed to the recipient behavioral identity node are aggregated to compute a composite trust value for a requested access or recovery function.

15. The system of claim 1, wherein the ledger anchor comprises an ActionLedger receipt, hash reference, signed audit record, timestamped event record, or append-only state transition reference.

16. The system of claim 1, wherein each directed trust edge includes metadata indicating physical proximity, co-location, relative device signal strength, or device authentication status.

17. The system of claim 1, wherein the access control module supports progressive disclosure by returning a validation result without disclosing an entire trust path to a verifier.

18. The system of claim 1, wherein at least a portion of a trust propagation path is encrypted, masked, summarized, or represented by a proof object during a third-party verification query so that a verifier can receive a trust result without receiving all intermediate node identifiers, edge weights, behavioral signal details, or timing details.

19. The system of claim 1, wherein the passive behavioral signal source comprises a Silent Echo module or an equivalent passive behavioral evidence module configured to provide behavior-derived entropy for trust score weighting, liveness evaluation, replay resistance, cryptographic binding, or trust-edge signature support.

20. The system of claim 1, wherein the access control module uses a risk-adaptive threshold to provide one of full access, limited access, temporary access, delayed access, step-up verification, manual review, offline emergency access, denial, revocation, or synchronization-required status.
